(19) United States
(12) Patent Application Publication
(10) Pub. No.: US 2017/0186291 A1
(43) Pub. Date: Jun. 29, 2017

(54) TECHNIQUES FOR OBJECT ACQUISITION AND TRACKING

(71) Applicants: Jakub WENUS, Maynooth (IE); Niall CAHILL, Galway (IE); Mark KELLY, Leixlip (IE); Keith NOLAN, Mullingar (IE); Cliodhna Ni Scanaill, Broadford (IE)

(72) Inventors: Jakub WENUS, Maynooth (IE); Niall CAHILL, Galway (IE); Mark KELLY, Leixlip (IE); Keith NOLAN, Mullingar (IE); Cliodhna Ni Scanaill, Broadford (IE)

(21) Appl. No.: 14/757,947

(22) Filed: Dec. 24, 2015

(51) Int. Cl. G08B 13/196; H04N 5/225; G03B 17/56; G08B 13/16; H04N 7/18; H04N 5/232

(52) U.S. Cl. CPC G08B 13/19608; H04N 7/181; H04N 5/23203; G03B 17/561; G08B 13/1672; H04N 5/2258

(57) ABSTRACT

A multimodal object tracking apparatus configured to identify a location for a target object within a defined physical space is described. The object tracking apparatus may include an acoustic component, a thermal component, and an analysis component. The acoustic component determines an approximate location for at least one sound object within the defined physical space. The thermal component determines an approximate location for at least one thermal object within the defined physical space. The analysis component identifies the target object when the approximate locations for at least one acoustic object and at least one thermal object match. Other embodiments are described and claimed.

### BACKGROUND

Object tracking involves monitoring behavior, activities, and other changing information associated with people and/or property located within a monitored space. The identification and tracking of objects is typically for the purpose of influencing, managing, directing, or protecting the associated people and/or property. To this end, video cameras have been used in object tracking systems to capture video of a monitored space. These video cameras are often connected to a recording device for storing and enabling future playback of captured video. Enabling future playback can allow an object tracking system to be used to identify a cause of changes in information associated with people and/or property monitored by the surveillance system.

### BRIEF DESCRIPTION OF THE DRAWINGS

FIG. 1A illustrates an embodiment of an object tracking apparatus.

FIG. 1B illustrates an embodiment of data acquisition devices of an object tracking apparatus.

FIG. 1C illustrates an exemplary block diagram of an object tracking apparatus.

FIG. 2 illustrates an embodiment of a multimodal object tracking application with a computer audio vision controller.

FIG. 3A illustrates an example of an acoustic image.

FIG. 3B illustrates an example of an acoustic image with sound objects.

FIG. 4 illustrates an embodiment of a multimodal object tracking application with a thermal image controller.

FIG. 5A illustrates an example of a thermal image.

FIG. 5B illustrates an example of a thermal image with thermal objects.

FIG. 6 illustrates an embodiment of a multimodal object tracking application with an image analysis component.

FIG. 7 illustrates an example of an acoustic/thermal image overlay.

FIG. 8 illustrates an embodiment of an object tracking apparatus with a video camera control component.

FIGS. 9A-D illustrate an embodiment of identifying and tracking a target object.

FIG. 10 illustrates an example process flow of identifying and tracking a target object.

FIG. 11 illustrates an embodiment of a set of object tracking apparatuses communicatively coupled to an IOT gateway.

FIG. 12 illustrates an embodiment of a first logic flow.

FIG. 13 illustrates an embodiment of a second logic flow.

FIG. 14 illustrates an embodiment of a third logic flow.

FIG. 15 illustrates an embodiment of a fourth logic flow.

FIG. 16 illustrates an embodiment of a fifth logic flow.

FIG. 17 illustrates an embodiment of a storage medium.

FIG. 18 illustrates an embodiment of a computing architecture.

FIG. 19 illustrates an embodiment of a communications architecture.

### DETAILED DESCRIPTION

Various embodiments are generally directed to object tracking techniques. Some embodiments are particularly directed to multimodal object tracking systems arranged to spatially analyze a defined physical space, such as the exterior of a secure building, for example. Multimodal spatial analysis may be used to identify, classify, and/or track objects of interest (e.g., sound, thermal, and/or target objects) within the defined physical space. These objects may be indicative of potentially adverse conditions or scenarios within the defined physical space. For instance, multimodal spatial analysis can be implemented to improve the identification of an object of interest in the defined physical space (e.g., a person or projectile traversing a monitored space). With reliable identification of an object of interest, the object may be tracked and monitored within the defined physical space.

One challenge facing object tracking systems is the ability to quickly and efficiently identify and track an object of interest in a monitored space (i.e. defined physical space) through spatial analysis. Accurate and intelligent object identification and tracking in real time can require the recording and analyzing of huge volumes of data corresponding to measured physical quantities (e.g., electromagnetic waves). Additionally, considerable network infrastructure and bandwidth may be needed for remote monitoring of the space. Adding further complexity, real world scenarios demand robust identification and tracking of an object in a variety of environmental conditions such as rain, snow, or fog. Such environmental conditions can interfere with identification and tracking of an object by blocking sensors collecting the necessary data to spatially analyze the monitored space. Faulty identification and/or tracking of objects can prevent successful monitoring of a defined physical space potentially preventing identification and tracking of an adverse condition or scenario.

Conventional solutions attempt to solve the difficulties associated with identifying and tracking an object of interest by employing custom systems requiring costly infrastructure, using complex signal processing algorithms, and/or requiring human operators to monitor the system. Human operators may increase cost and decrease efficiency of an object tracking apparatus. Complex visual recognition algorithms demand relatively large amounts of energy and may still be tricked by varying environmental conditions, causing such algorithms to be inefficient and unreliable. Further, customized systems drastically reduce the flexibility of object tracking systems. Such techniques may entail needless complexity, large energy demands, high costs, and poor efficiency.

To solve these and other problems, various embodiments include two or more additional modalities, other than video, to localize an object of interest in order to improve the efficiency and accuracy of object tracking systems. The additional modalities may entail the use of additional signals in combination with video signals to accurately spatially analyze a defined physical space room to identify and track an object of interest. Further, each modality may be selectively implemented to efficiently identify and track the object of interest.

In one embodiment, the additional modalities may entail the use of audio signals in combination with thermal signals to improve efficiency and accuracy of spatially analyzing a defined physical space to identify and track an object of interest. For example, a video tracking system with a video camera may be augmented with a microphone array and a thermal camera to improve object localization. Efficiency of object localization can be realized by selectively utilizing each modality of the system, thereby reducing energy demands of the system. For instance, the microphone array may power on when the system is activated. The microphone array can be utilized to initially identify and approximate the location of an object of interest. Once the location has been approximated, the thermal camera may power on to refine the approximate location of the object of interest. Then, when the location has been refined, the video camera is powered on to record visual footage of the object of interest.

Improved accuracy of object localization can be realized because the modalities are complementary and provide redundancy. For instance, in complete darkness a video camera does not detect any signal, while a sound sensor is unaffected and a thermal sensor has the highest signal-to-noise ratio. The microphone array may identify and track various sound signatures (i.e. sound objects), such as the footsteps of a person. The wide-angle thermal imaging camera may identify and track various heat signatures (i.e. thermal objects), such as a body heat of a person.

With general reference to notations and nomenclature used herein, portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modification, equivalents, and alternatives within the scope of the claims.

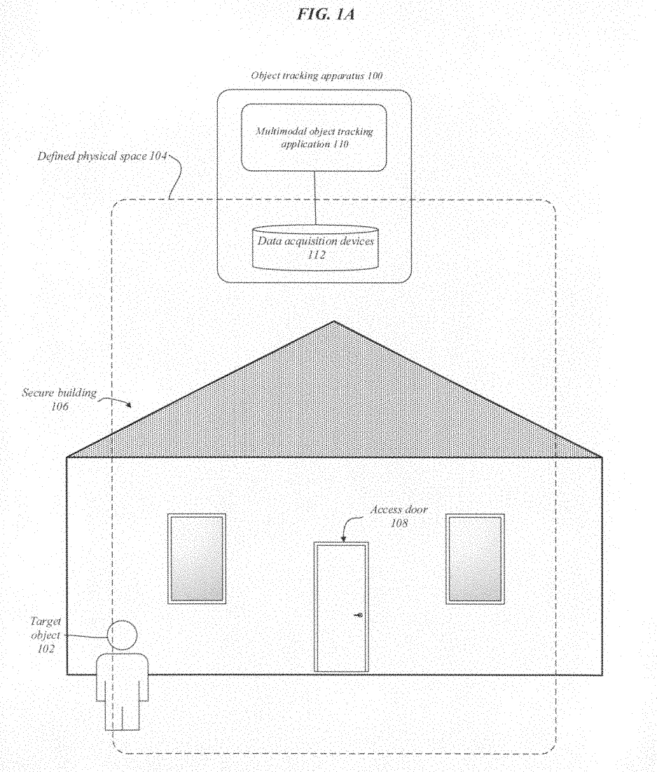

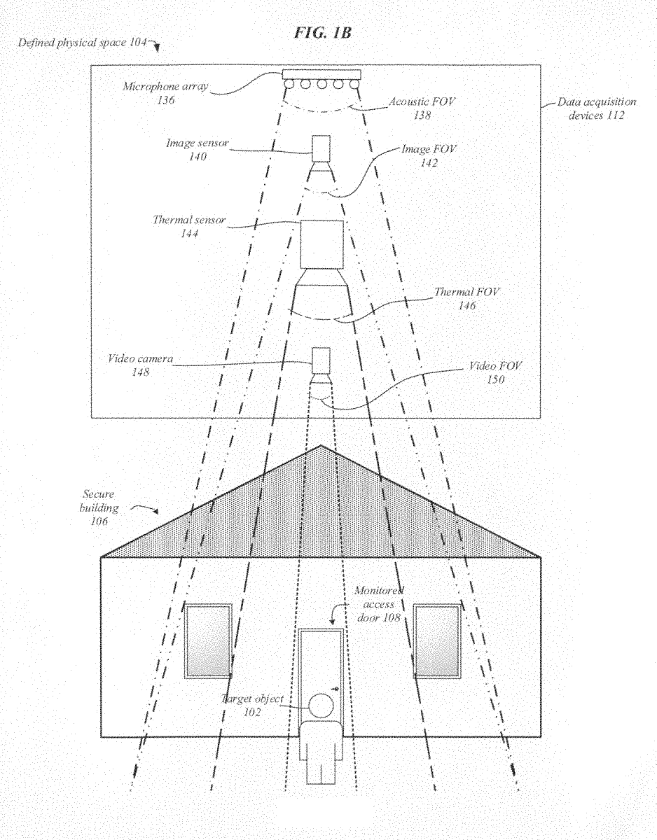

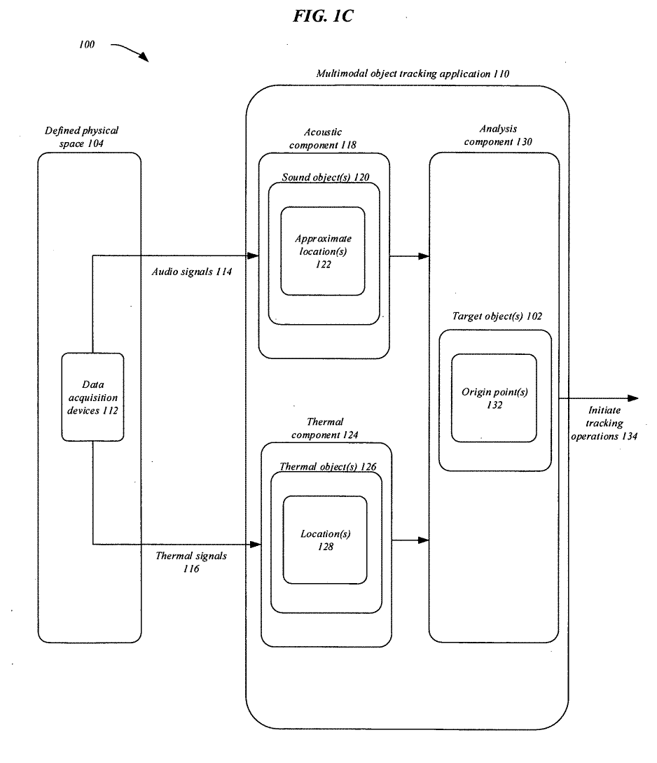

FIG. 1A illustrates one embodiment of an object tracking apparatus 100. The object tracking apparatus 100 may be used to monitor a target object 102 when it is within a defined physical space 104, such as the exterior of a secure building 106 proximate an access door 108. Monitoring the defined physical space 104 may include identifying and tracking objects located within (moving or stationary) the space 104. To monitor the defined physical space 104, the object tracking apparatus 100 may use data acquisition devices 112 communicatively coupled with a multimodal object tracking application 110. The multimodal object tracking application 110 can be implemented by one or more hardware components described herein such as a processor and memory. In various embodiments, the data acquisition device 112 and the multimodal object tracking application 110 may interoperate to perform spatial analysis on the defined physical space 104 to improve the efficiency and accuracy with which objects can be identified and tracked within the defined physical space 104. In various such embodiments, spatial analysis of the defined physical space 104 may enable the object tracking apparatus 100 to identify a target object 102 (e.g., person, animal, projectile, machine, etc.), upon which to focus or localize the capture data by the data acquisition devices 112. In some embodiments, the data associated with the target object 102 may be captured in a plurality of modalities such as acoustic, thermal, and/or electromagnetic spectrums. The data collected in the different modalities from monitoring the target object 102 may be utilized by the multimodal object tracking application 108 to identify, classify (e.g., prioritize, rank, tag), and track the target object 102

The defined physical space 104 may represent any physical environment in which it is desired to identify and/or track one or more objects. In various embodiments the object tracking apparatus may create a record of activity that occurs within the defined physical space 104. In various such embodiments the record of activity within the defined physical space 104 can be used to identify and/or resolve potentially adverse conditions or scenarios in real time. For example, the defined physical space 104 may comprise the exterior of secure building 106 surrounding an access door 108. In this example, the object tracking apparatus 100 may allow all entry via the access door 108 to be recorded.

The data acquisition device 112 may be included in the defined physical space 104 to capture physical parameters of the defined physical space 104 via the data acquisition devices 112. These physical parameters may be used by the multimodal object tracking application 110 to identify, prioritize, and/or track target object(s) 102 within the defined physical space 104. In some embodiments, the target object 102 can include a human being engaged in walking.

FIG. 1B illustrates an embodiment of a data acquisition device 112 of the object tracking apparatus 100. The data acquisition device 112 may be used by the object tracking apparatus 100 to monitor the defined physical space 104. The data acquisition devices 112 may include various types of input devices or sensors (hereinafter collectively referred to as a “sensor”). As shown in FIG. 1B, the data acquisition device 112 comprises a microphone array 136, an image sensor 140, a thermal sensor 144, and a video camera 148. In some cases, the sensors may be implemented separately, or combined into a sub-set of devices. In one embodiment, for example, the microphone array 136 and the image sensor 140 may be implemented as part of an acoustic camera. It may be appreciated that the data acquisition device 112 may include more or less sensors as desired for a given implementation. Embodiments are not limited in this context.

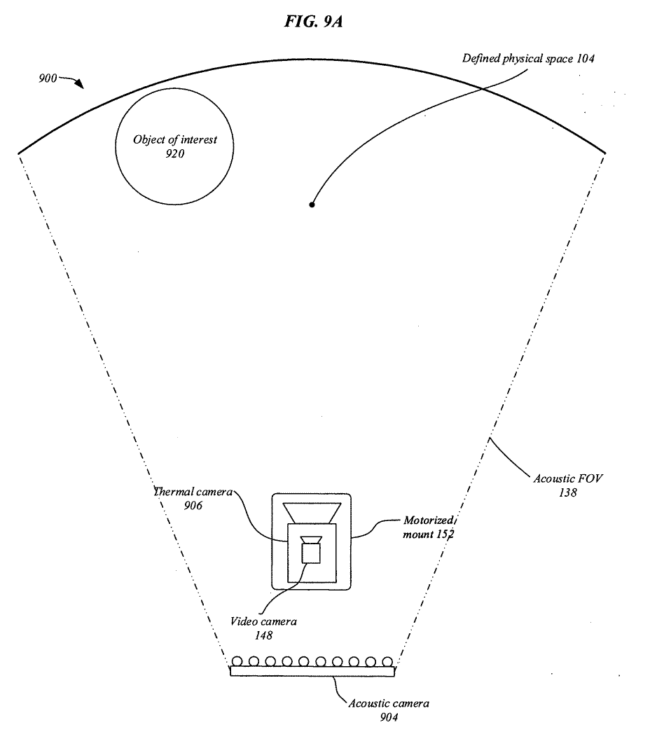

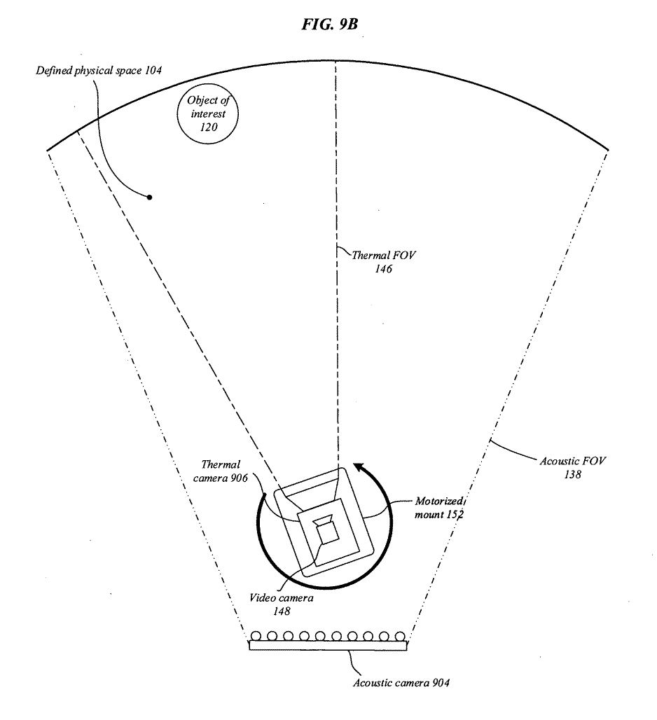

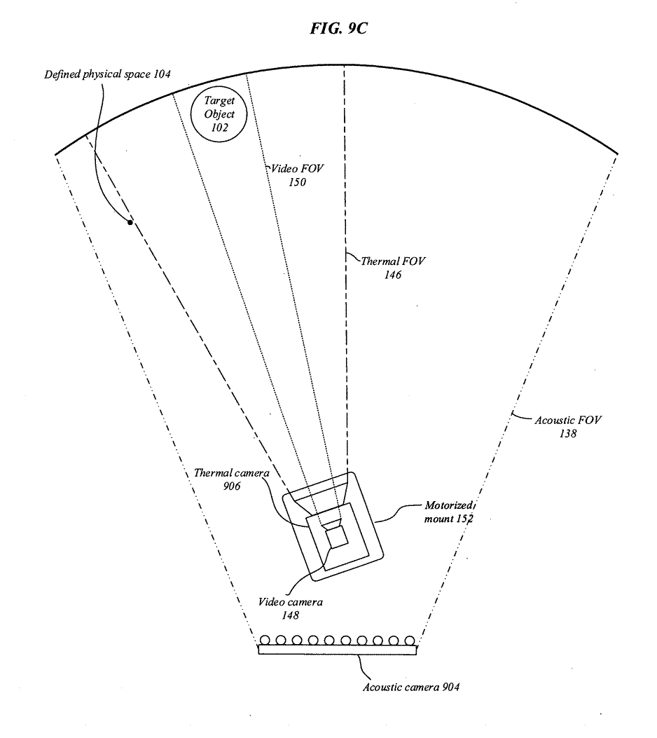

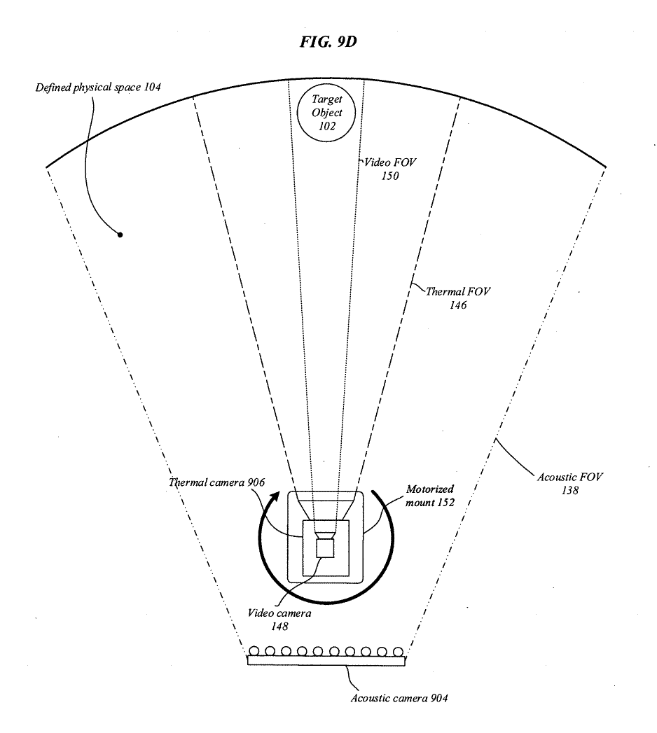

The microphone array 136 can have a plurality of independent microphones. The microphones may be arranged in a number of configurations in up to three dimensions. For example, the microphones in the microphone array may be arranged in a linear, grid, or spherical manner. Each microphone can encode a digital signal based on measured levels of acoustic energy. In various embodiments the microphone array may convert acoustic pressures from the defined physical space 104 to proportional electrical signals or audio signals for receipt by the multimodal object tracking application 110. In various such embodiments the multimodal object tracking application 110 may spatially analyze the defined physical space 104 based on the received signals. In one embodiment the microphone array 136 may include directional microphone array arranged to focus on a portion of the defined physical space 104. In some embodiments the microphone array 135 may comprise a portion of an acoustic camera (see, e.g., acoustic camera 904 in FIG. 9).

The image sensor 140 may encode a digital signal based on electromagnetic waves detected within the defined physical space 104. In various embodiments the image sensor 140 may convert electromagnetic waves from the defined physical space 104 to proportional electrical signals or image signals. In various such embodiments, the image sensor 140 may be utilized in conjunction with the microphone array 136 to perform a low resolution spatial analysis of the defined physical space 104 to identify and/or track objects of interest. In some embodiments the image sensor 140 may comprise a portion of an acoustic camera (see, e.g., acoustic camera 904 in FIG. 9). In various embodiments the image sensor 140 may comprise a video camera with lower resolution and fewer frames per second than video camera 148. In other embodiments the video camera 148 may serve the purpose of the image sensor 140.

The thermal sensor 144 may encode a digital signal based on measured intensities of thermal energy in the defined physical space 104. In various embodiments the thermal sensor 144 may convert heat from the defined physical space 104 to proportional electrical signals or thermal signals. In various such embodiments the thermal sensor 144 may be utilized in conjunction with the microphone array 136 and/or the image sensor 140 to perform a medium resolution spatial analysis of the defined physical space 104 to identify and/or track target objects 102. In some embodiments the thermal sensor 144 may comprise a thermal camera (see, e.g., thermal camera 906 in FIG. 9).

The video camera 148 may encode a digital signal based on measured intensities of visible light received from the defined physical space 104. In various embodiments the video camera 148 may convert visible light from the defined physical space 104 to proportional electrical signals or video signals. In various such embodiments, the video camera may be utilized in conjunction with one or more other sensors of the data acquisition devices 112 to perform a high resolution spatial analysis of the defined physical space 104 to identify and track target objects 102.

In various embodiments, each sensor in the data acquisition device 112 may have a respective field of view (FOV) or capture domain. The FOV may cause the data acquisition devices 112 to observe or capture a particular scene or image of the defined physical space 104. A scene or image of the defined physical space 104 may be represented by a state of the defined physical space 104 at a given moment in time. As shown in FIG. 1B, the microphone array 136 may have an acoustic FOV 138, the image sensor may have an image FOV 142, the thermal sensor 144 may have a thermal FOV 146, and the video camera 148 may have a video FOV 150. In various embodiments, the FOVs 138, 142, 146 and/or 150 may be different sizes, separate, adjacent, adjoining or overlapping with each other. Embodiments are not limited in this context.

In some embodiments the FOV of each data acquisition device may overlap at least a portion of the other FOVs. In the exemplary embodiment shown in FIG. 1B, the video camera 148 has a narrow FOV 150, the thermal sensor 144 may have a medium FOV 146 that completely overlaps the video FOV 150, while the image sensor 140 and the microphone array 136 have a wide FOV that completely overlaps the thermal FOV 146, the video FOV 150, the defined physical space 104.

Overlapping the FOVs in this manner can enable selective activation and deactivation of sensors in the data acquisition devices 112. For instance, the microphone array 136 and the image sensor 140 may have spatially aligned FOVs that are wide enough to spatially analyze the entire defined physical space 104 at a low resolution, but at a fraction of the power needed to operate all of the data acquisition devices 112. Accordingly, the apparatus 100 may rely on the microphone array 136 and the image sensor 140 to initially detect an object of interest and approximate its location, while the thermal sensor 144 and the video camera 148 are powered down. Once the approximate location of the object of interest is determined, the thermal sensor 144 may be powered on to verify the object of interest is a target object 102 and refine the location of the target object 102. When the object of interest has been verified as a target object 102 and its location has been refined, tracking operations may be initiated and the video camera 150 may be powered on to provide high resolution images of the target object 102. Thus, by selective activation and implementation of various sensors of the data acquisition devices 112, the energy demands for object identification and tracking can be reduced, thereby improving efficiency of the apparatus 100.

FIG. 1C illustrates a block diagram of an exemplary embodiment of object tracking apparatus 100. The object tracking apparatus 100 may include the data acquisition devices 112 and a multimodal object tracking application 110. The multimodal object tracking application may receive audio and thermal signals 114, 116 from one or more sensors of the data acquisition device 112. In various embodiments the received signals 114, 116 are analyzed by the multimodal object tracking application 110 to identify a target object 102 and an associated origin point 132. For example, the multimodal object tracking application 110 may identify a target object 102, such as human being or a projectile, based on signals detected by the data acquisition device 112 in the defined physical space 104, such as an access door to a secure facility. Once the object has been identified, tracking operations may be initiated 134. Embodiments are not limited in this context.

As shown in FIG. 1C, the multimodal object tracking application 110 may include an acoustic component 118, a thermal component 124, and an analysis component 130. In some embodiments the acoustic component 118 may initially approximate a location 122 for an object of interest or sound object 120. The thermal component 124 may then be utilized to refine the approximate location 122 of the sound object 120 using a corresponding thermal object 126 with location 128. The embodiments are not limited in this context.

The acoustic component 118 may receive audio signals 114 and the thermal component 124 may receive thermal signals 116 detected in the defined physical space 104. From the received audio signals 114, the acoustic component 118 may determine one or more sound objects 120 and corresponding approximate locations 110 for each sound object 120. In some embodiments a sound object 120 comprises an object of interest. The thermal component 124 may determine one or more thermal objects 126 and corresponding approximate locations 128 for each thermal object 120 from the received thermal signals 116. In some embodiments, the thermal component 124 may only begin to receive thermal signals 116 from the data acquisition devices 112 once a sound object 120 has been identified by the acoustic component 118. In various embodiments, the sound and thermal objects 120, 126 may represent sound and/or heat generating objects within the defined physical space 104. In other words, sound objects 120 may include any object in the defined physical space that emits sound energy above ambient levels. Similarly, thermal objects 120 may include any object in the defined physical space 104 that emits thermal energy above ambient levels.

In various embodiments, a sound generating object must satisfy a sound energy threshold 208 to be identified as an object of interest or a sound object 120. In various such embodiments, the thermal component 124 may not begin to receive thermal signals 116 to detect thermal objects 126 and their approximate locations 128 until after the acoustic component 118 has identified an object of interest in the defined physical space 104. In some embodiments, at least one of the sound objects 120 represents a human being. In some embodiments, at least one of the thermal objects 126 represents a human being. The approximate locations 110, 128 of the sound and thermal objects 120, 126 may then be passed to the analysis component 130 for identification of the target object 102, such as a human being engaged in movement.

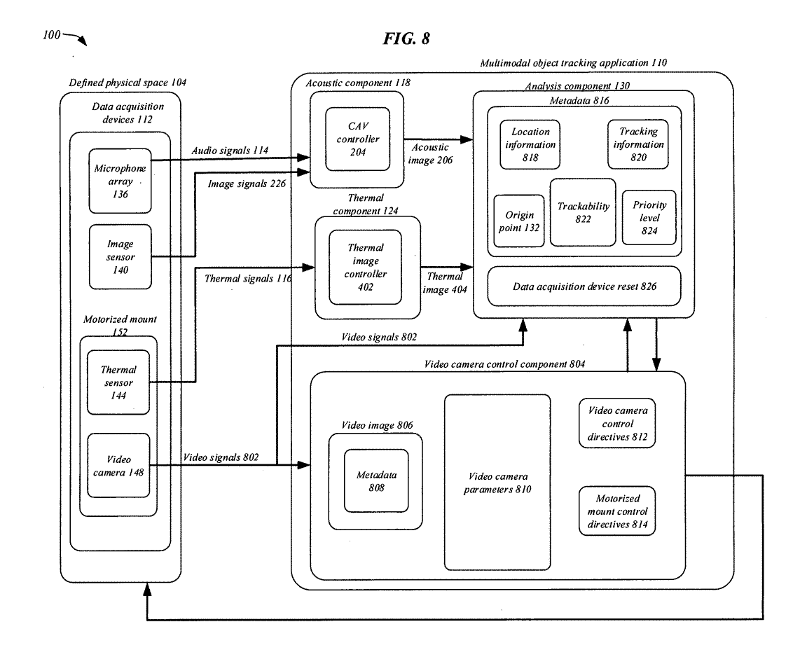

The approximate locations 110, 128 may be received by the analysis component 130 for identification of a target object 102 and its origin point 132. In some embodiments locations 128 received from the thermal component 124 are used by the analysis component 130 to refine the locations 122 received from the acoustic component 118. In various embodiments, the origin point 132 of the target object 102 must correspond to an approximate location 122 of at least one sound object 120 that matches an approximate location 128 of at least one thermal object 128. In various such embodiments, the requirement of matching locations with regard to at least one thermal object 126 and at least one sound object 120 may provide an operation to verify the origin point 132 of the target object 102 is properly identified. The verification can improve the accuracy and reliability of the ability of the object tracking apparatus 100 to identify the target object 102. In some embodiments matching sound and thermal object approximate locations 110, 128 may identify a location of a human being standing within the defined physical space 104, as the target object 102. Once the target object 102 and the associated origin point 132 has been identified by the analysis component 130, the multimodal object tracking application 110 may initial tracking operations 134. These tracking operations 134 will be described in more detail below with respect to FIGS. 8-9D.

In various embodiments one or more portions of the object tracking apparatus 100, such as the acoustic component 118, the thermal component 124, and/or the analysis component 130, may be implemented in logic. In various such embodiments the logic may be implemented as part of a system-on-chip (SOC) and/or a mobile computing device. In an embodiment, the system 100 may be embodied in varying physical styles or form factors. For example, the system 100, or portions of it, may be implemented as a mobile computing device having wireless capabilities. A mobile computing device may refer to any device having a processing system and a mobile power source or supply, such as one or more batteries, for example. Some such examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In some embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

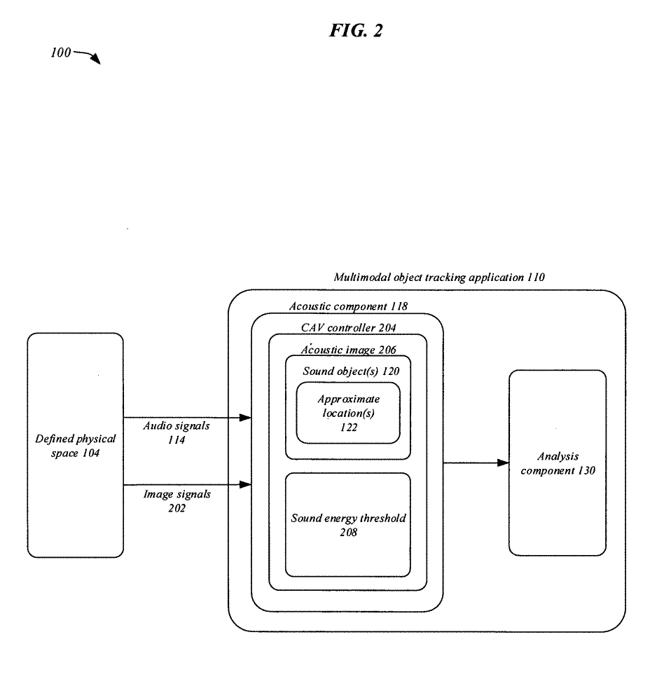

FIG. 2 illustrates an exemplary embodiment of an object tracking apparatus 100 with a computer audio vision (CAV) controller 204. The CAV controller 204 may be enable the object tracking apparatus 100 to generate an acoustic image 206 of a defined physical space 104, such as an access door to a secured building, based on audio and image signals 114, 202. The acoustic image 206 may be used in conjunction with the approximate locations 128 of thermal objects 126 to improve the accuracy of identifying target objects 102 by the analysis component 130. In the illustrated embodiment, the CAV controller 204 comprises a portion of acoustic component 118. In some embodiments the CAV controller 204 may comprise part of an acoustic camera. The embodiments are not limited in this context.

The acoustic image 206 may illustrate at least one sound object 120 and its corresponding approximate location 122. For instance, the acoustic image 206 may include a visual representation of sound energy detected by the data acquisition device 112 in a defined physical space 104. The visual representation of sound energy may be evaluated by the system 100 to identify approximate locations of sound objects 120 in defined physical space 104. In various embodiments the acoustic image 206 may represent an image or scene of the defined physical space 104 at a given moment in time. In various such embodiments, the acoustic image 206 may be represented by a multi-dimensional set of pixels with each pixel representing a level of sound energy received from a unique portion of the defined physical space 104. When a sub-set of the pixels satisfies a sound energy threshold 208 (e.g. sufficiently above ambient levels), the unique portion of the defined physical space 104 it corresponds to may be identified in the acoustic image 206 as an approximate location 122 for a sound object 120. In some embodiments, the at least one sound object may be represented by a sub-set of pixels in the acoustic image 206.

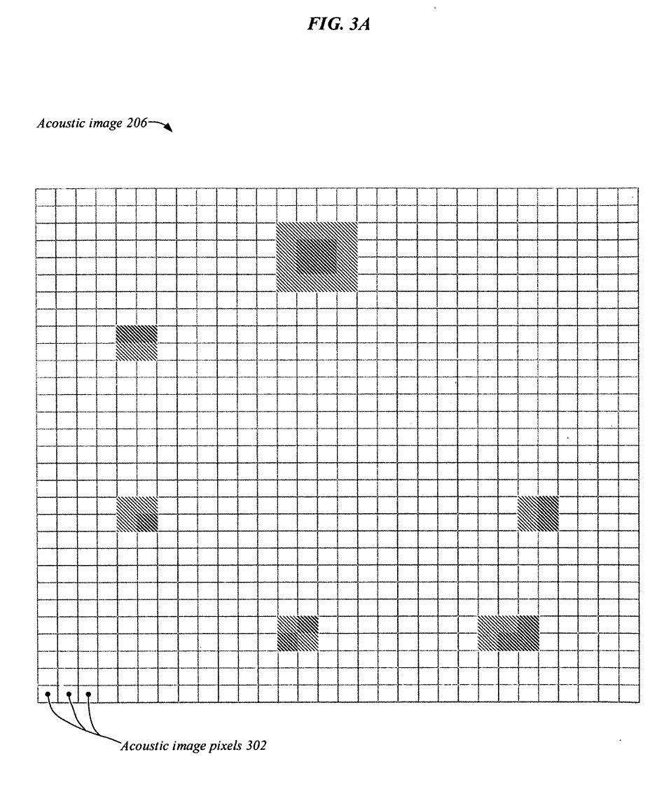

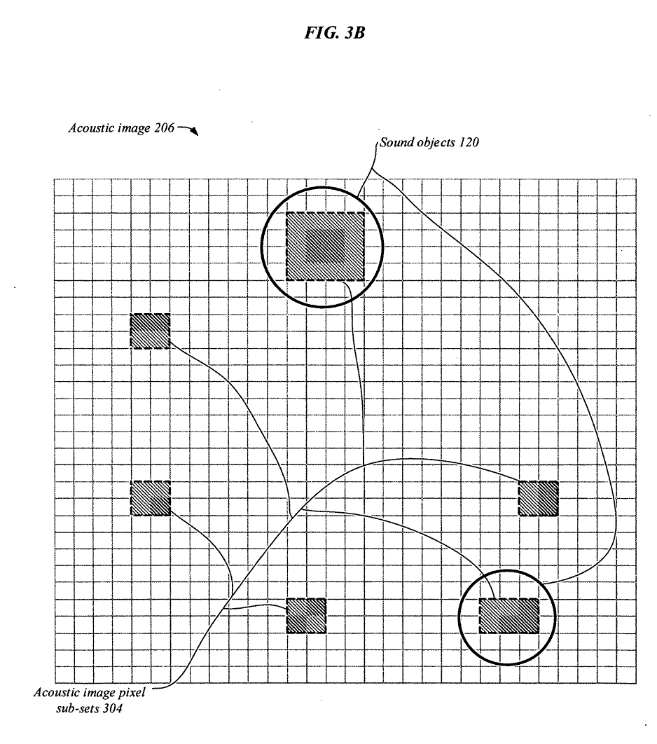

FIG. 3A illustrates one example of an acoustic image 206. The acoustic image may be represented as a two-dimensional grid of acoustic image pixels 302. To this end, pixel intensity of each pixel of a generated acoustic image 206 represents sound intensity from each unique angle of arrival of sound (azimuth and elevation). This may facilitate ready identification or labelling of a target object 102 or its corresponding origin point 132. Accordingly, the intensity or level of sound energy may be visually represented by the degree of shading of a respective acoustic image pixel. In the illustrated embodiment, a darker shading represents a higher level of sound energy arriving from the corresponding portion of the defined physical space 104. The embodiments are not limited in this context.

FIG. 3B illustrates an example of an acoustic image 206 with sound objects 120. As previously described, the CAV controller 204 may generate acoustic image 206 to improve sound source localization. The pixels 302 of the acoustic image 206 may be evaluated by one or more components of the object tracking apparatus 100 such as the CAV controller 204 to identify sound objects 120 in a defined physical space 104 such as a conference room. In the illustrated embodiment, the pixels 302 are evaluated in acoustic image pixel sub-sets 304. The embodiments are not limited in this context.

In some embodiments acoustic image pixel sub-sets 304 may be selected for evaluation. Based on the evaluation, a sound energy value can be generated for each sub-set of pixels 304. The sound energy value can, in turn, be used to determine if a sub-set of pixels 304 should be labeled as a sound object 120. For example, whether the sound energy value satisfies a set of one or more conditions can determine when a sub-set of pixels 304 is identified as sound object 120. The set of one or more conditions may include parameters such as minimum and/or maximum sound energy values. In some embodiments the set of one or more conditions may include sound energy threshold 208 that must be met or exceeded for the respective sub-set of pixels 304 to be identified as a sound object 120 or an object of interest.

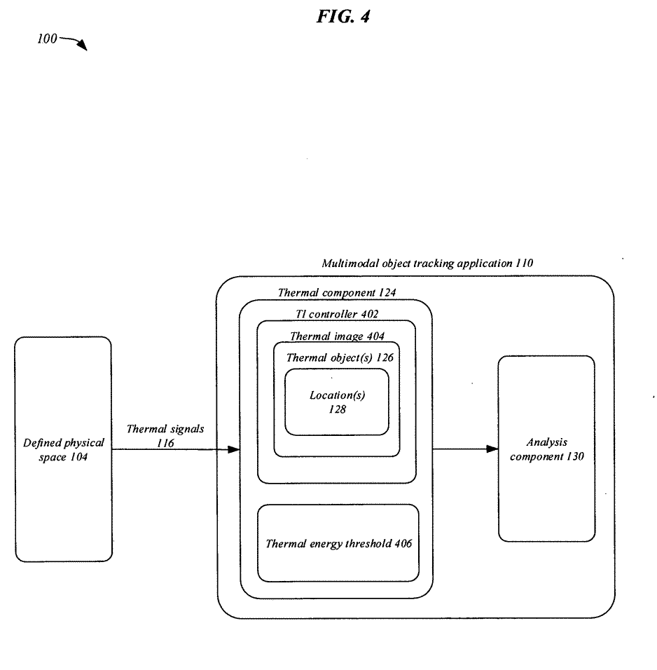

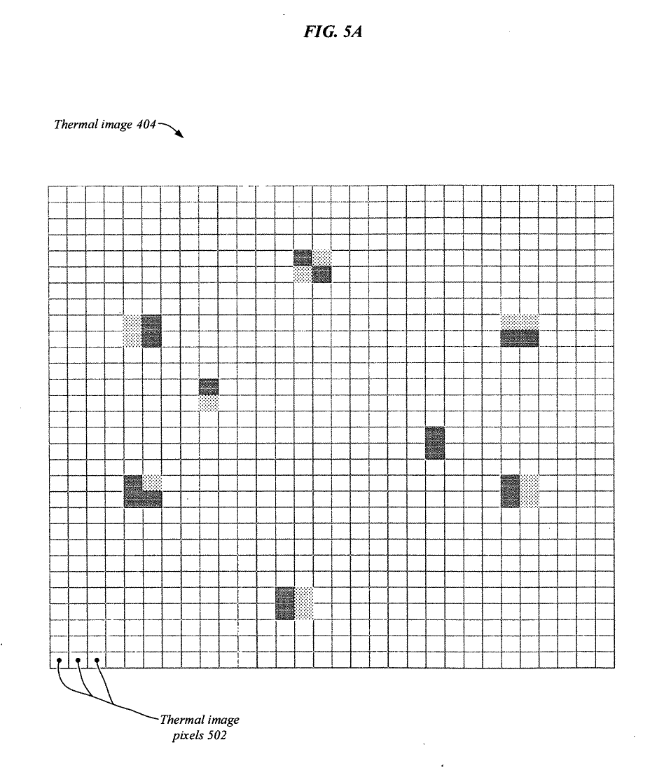

FIG. 4 illustrates an exemplary embodiment of an object tracking apparatus 100 with a thermal image (TI) controller 402. In some embodiments the thermal component 124 may only be utilized by the apparatus 100 after a sound object 120 has been identified by acoustic component. The TI controller 402 may be enable the object tracking apparatus 100 to generate a thermal image 404 of a defined physical space 104, such as a conference room, based on thermal signals 116. The thermal image 404 may be used in conjunction with the acoustic image 206 to improve accurate identification of the target object 102 by the analysis component 130. In the illustrated embodiment, the TI controller 402 forms a portion of thermal component 124. In some embodiments the TI controller 402 may comprise part of a thermal camera. The embodiments are not limited in this context.

The thermal image 404 may depict at least one thermal object 126 and its corresponding approximate location 128. For instance, the thermal image 404 may include a visual representation of thermal energy detected by the data acquisition device 112 in a defined physical space 104. The visual representation of thermal energy may be evaluated by the system 100 to identify locations of thermal objects 126 in defined physical space 104, such as an access door to a secure facility. In some embodiments, the thermal component 124 may function to refine an approximate location 122 of a sound object 120 or object of interest. In various embodiments the thermal image 404 may represent an image or scene of the defined physical space 104 at a given moment in time. In various such embodiments, the thermal image 404 may be represented by a multi-dimensional set of pixels with each pixel representing a level of thermal energy received from a unique portion of the defined physical space 104. When a sub-set of the pixels satisfies thermal energy threshold 406 (e.g. sufficiently above ambient levels), the unique portion of the defined physical space 104 it corresponds to may be identified in the thermal image 404 as a location 128 for a thermal object 126. In some embodiments, the at least one thermal object may be represented by a sub-set of pixels in the thermal image 404.

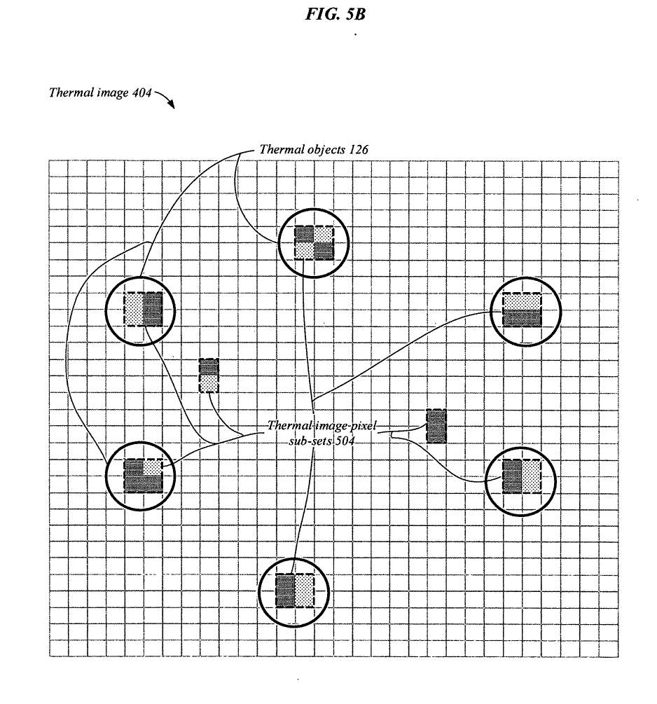

FIG. 5A illustrates one example of a thermal image 404. The thermal image 404 may be represented as a two-dimensional grid of thermal image pixels 502. To this end, pixel intensity of each pixel of a generated thermal image 404 represents thermal energy intensity from each unique angle of arrival of thermal energy (azimuth and elevation). This may facilitate ready identification or labelling of a target object 102. Accordingly, the intensity or level of thermal energy may be visually represented by the degree of shading of a respective thermal image pixel 502. In the illustrated embodiment, a darker shading represents a higher level of thermal energy arriving from the corresponding portion of the defined physical space 104. The embodiments are not limited in this context.

FIG. 5B illustrates an example of a thermal image 404 with thermal objects 126. As previously described, the TI controller 402 may generate thermal image 404. The thermal image 404 may be evaluated by one or more components of the object tracking apparatus 100. In the illustrated embodiment, the thermal image 404 can be evaluated by the TI controller 402. The embodiments are not limited in this context.

As part of the evaluation, thermal image pixel sub-sets 504 may be selected. A thermal energy value can be generated for each sub-set of pixels 504. Based on the thermal energy value, a sub-set of pixels 504 may be labeled as a thermal object 126. Whether the thermal energy value satisfies a set of one or more conditions can determine when a sub-set of pixels 504 may be identified as a thermal object 126. The set of one or more conditions may include parameters such as minimum and/or maximum thermal energy values. In various embodiments the set of one or more conditions may include thermal energy threshold 406 that must be met for the respective sub-set of pixels 504 to be identified as a thermal object 126. In various such embodiments the threshold thermal energy value may represent a heat signature for a human being. In other embodiments the threshold thermal energy value can represent a heat signature for a non-human object. In other such embodiments when the thermal energy value for a sub-set of pixels 504 is lesser than or equal to a threshold thermal energy value, the sub-set of pixels 504 is not identified as a thermal object 126. The embodiments are not limited in this context.

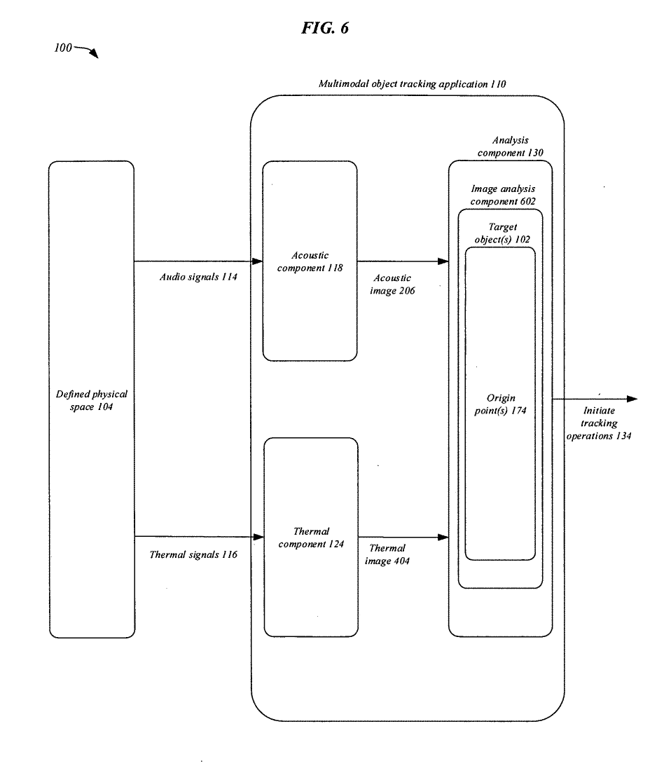

FIG. 6 illustrates an embodiment of a multimodal object tracking application 110 with an image analysis component 602. The image analysis component 602 may identify a target object 102 in the defined physical space 104 by using an acoustic image 206 and a thermal image 404. In some embodiments the acoustic and thermal images 206, 404 are spatially and temporally aligned. The target object location 102 may be identified by the image analysis component 602 based on a comparison of the acoustic and thermal images 206, 404. In the illustrated embodiment, the image analysis component 602 can be included in the analysis component 130. The embodiments are not limited in this context.

As previously described, the analysis component 130 may receive an acoustic image 206 generated by an acoustic component 118, such as the CAV controller 204, based on audio signals 114 and/or image signals 202 received from the defined physical space 104. Further the analysis component 130 may receive a thermal image 404 generated by a thermal component 124, such as TI controller 402 based on thermal signals 116 received from the defined physical space 104.

The image analysis component may evaluate the acoustic image 206 and the thermal image 404 to identify the target object 102 and its origin point 132. In various embodiments the acoustic image 206 and the thermal image 404 may be evaluated by creating an acoustic/thermal image overlay 702. In various such embodiments the image analysis component may spatially and temporally align two images 206, 404 to create the acoustic/thermal image overlay 702. In some embodiments the image analysis component 602 may execute various post-processing routines to perform spatial and temporal alignments. Note that spatial and temporal alignments may be performed by one or more other components of the object tracking apparatus 100. For instance, the data acquisition device 112 may include hardware, software, or any combination thereof to spatially and/or temporally align the acoustic and thermal images 206, 404.

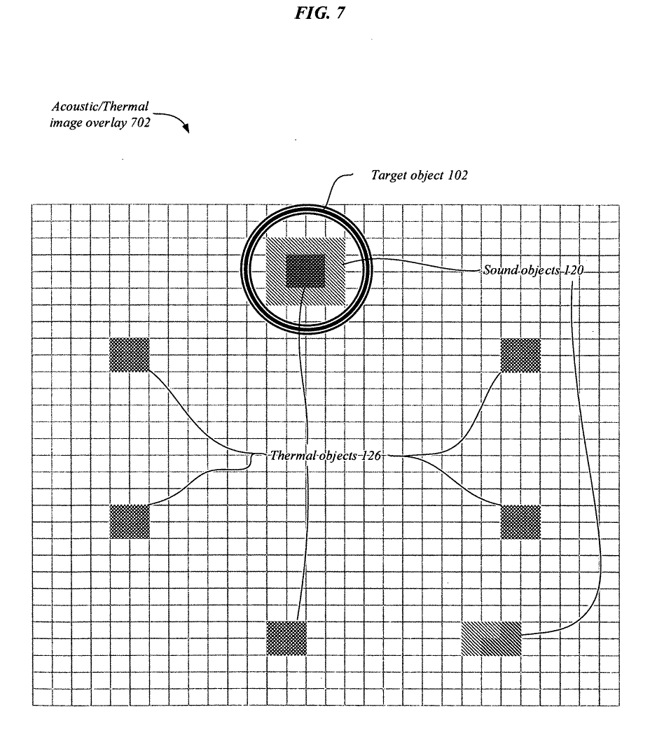

FIG. 7 illustrates one example of an acoustic/thermal image overlay 702. The acoustic/thermal image overlay 702 may comprise a composite of the acoustic image 206 and the thermal image 404. The acoustic/thermal image overlay 702 may include sound objects 120 and thermal objects 126. The relative locations or positions of the sound and thermal objects 120, 126 may be compared to identify the target object 102. For instance, when the locations of a sound object 120 and a thermal object 126 are matching or approximately the same, that location can be identified for the target object 102. The embodiments are not limited in this context.

In some embodiments the acoustic image 206 and the thermal image 404 may include the same number and correlation of pixels. This may assist with spatial alignment of the images 206, 404 by providing a one-to-one relationship between acoustic image pixels 302 and thermal image pixels 502. The one-to-one relationship between image pixels 302, 502 can allow one of the images 206, 404 to be superimposed on top of the other image, resulting in creation of the acoustic/thermal image overlay 702.

As discussed previously, the thermal component 124 may be used to refine the approximate location of an object of interest or a sound object 120. To this end, as shown in FIG. 7, the sound object 120 located proximate the target object 102 includes 16 pixels of the acoustic/thermal image overlay 702, while the thermal object 120 located proximate the target object 102 only includes 4 pixels. As may be appreciated, by identifying a group of only 4 pixels as an object as opposed to a group of 16 pixels the thermal component 124 can operate to refine the location of the target object 102. Once the location of the target object has been refined video camera 148 (see FIG. 1B) may be used to record visual images on the target object 102.

FIG. 8 illustrates an embodiment of an object tracking apparatus 100 with a video camera control component 804 and data acquisition devices 112. The data acquisition device 112 may be located in a defined physical space 104. As described above, the data acquisition device 112 may include sensors such as microphone array 106, image sensor 140, thermal sensor 110, and video camera 148. The data acquisition device 112 may be used to capture physical parameters of the defined physical space 104. These physical parameters may include light, acoustic, and/or thermal energy. The physical parameters may be converted into audio, image, and thermal signals 114, 202, 116 by the data acquisition device 112 to enable spatial analysis of the defined physical space 104. The embodiments are not limited in this context.

The microphone array 136 may have one or more microphone devices. The one or more microphone device can include a unidirectional microphone type, a bi-directional microphone type, a shotgun microphone type, a contact microphone type, a parabolic microphone type or the like. The microphone array 136 can be implemented as, for example, any number of microphones devices that can convert sound (e.g., acoustic pressures) into a proportional electrical signal (e.g., audio signals 114). In the general context of the techniques discussed herein, the microphone array 136 is a 2-D microphone array having an M×N pattern of microphone devices, but other microphone array configurations will be apparent in light of this disclosure. One such example 2-D microphone array with an 8×8 microphone array of a uniform linear array pattern. Each microphone is positioned in a particular row and column and thus can be addressed individually within the array of microphones. It should be appreciated that in other embodiments, the microphone array could be configured in different patterns such as, for example, circular, spiral, random, or other array patterns. Note that in the context of distributed acoustic monitoring systems, the array of microphones 120 may comprise a plurality of microphone arrays that are local or remote (or both local and remote) to the system 100. The embodiments are not limited in this context.

Each microphone of microphone array 136 can be implemented as, for example, a microphone device with an omnidirectional pickup response such that response is equal to sounds coming from any direction. In an embodiment the omnidirectional microphones can be configured to be more sensitive to sounds coming from a source perpendicular to the broadside of microphone array 136. Such a broadside array configuration is particularly well-suited for targeting sound sources in front of the microphone array 136 versus sounds originating from, for instance, behind the microphone array 136. Other suitable microphone arrays can be utilized depending on the application, as will be apparent in light of this disclosure. For example, end-fire arrays may be utilized in applications that require compact designs, or those applications that require high gain and sharp directivity. In other embodiments, each microphone can comprise a bi-directional, unidirectional, shotgun, contact, or parabolic style microphone. As generally referred to herein, a contact microphone can enable detecting sound by having the microphone in contact or close proximity with an object (e.g., a machine, a human). For example, a contact microphone could be put in contact with the outside of a device (e.g., a chassis) where it may not be possible or otherwise feasible to have a line of sight with the target device or object to be monitored.

As shown in the example microphone array 136, each microphone is comprised of identical microphone devices. One such specific example includes MEMS-type microphone devices. In other embodiments, other types of microphone devices may be implemented based on, for example, form factor, sensitivity, frequency response and other application-specific factors. In a general sense, identical microphone devices are particularly advantageous because each microphone device can have matching sensitivity and frequency response to insure optimal performance during audio capture, spatial analysis, and spatial filtering (i.e. beamforming). In an embodiment, microphone array 136 can be implemented within a housing or other appropriate enclosure. In some cases, the microphone array 136 can be mounted in various ways including, for instance, wall mounted, ceiling mounted and tri-pod mounted. In addition, the microphone array 136 can be a hand-held apparatus or otherwise mobile (non-fixed). In some cases, each microphone can be configured to generate an analog or digital data stream (which may or may not involve Analog-to-Digital conversion or Digital-to-Analog conversion).

It should be appreciated in light of this disclosure that other types of microphone devices could be utilized and this disclosure is not limited to a specific model, or use of a single type of microphone device. For instance, in some cases it may be advantageous to have a subset of microphone devices with a flat frequency response and others having a custom or otherwise targeted frequency response. Some such examples of a targeted frequency response include, for instance, a response pattern designed to emphasize the frequencies in a human voice while mitigating low-frequency background noise. Other such examples could include, for instance, a response pattern designed to emphasize high or low frequency sounds including frequencies that would normally be inaudible or otherwise undetectable by a human ear. Further examples include a subset of the microphone array 136 having a response pattern configured with a wide frequency response and another subset having a narrow frequency response (e.g., targeted or otherwise tailored frequency response). In any such cases, and in accordance with an embodiment, a subset of the microphone array 136 can be configured for the targeted frequency response while the remaining microphones can be configured with different frequency responses and sensitivities.

As shown, data acquisition device 112 may include a video camera 148 and an image sensor 140. Generally, the video camera 148 has a higher resolution and frame rate, but a narrower FOV than image sensor 140. On the other hand, although the image sensor 140 has a lower resolution and frame rate, it has a wider FOV to allow it to monitor the entire define physical space without being repositioned. To this end, the video camera 148 may be attached to a motorized mount to enable its FOV to be directed to any location in the defined physical space 104.

The video camera 148 and image sensor 140 may be implemented as any type of sensor capable of capturing electromagnetic energy and converting it into a proportional electrical signal including, for example, CMOS, CCD and hybrid CCD/CMOS sensors. Some such example sensors include, for instance, color image data (RGB), color and depth image data (RGBD camera), depth sensor, or stereo camera (L/R RGB). Although a single image sensor 140 and a single video camera 148 is depicted in FIG. 1B, it should be appreciated additional sensors and sensor types can be utilized (e.g., multiple cameras arranged to photograph a scene of a defined physical space from different perspectives) without departing from the scope of the present disclosure. To this end, image sensor 140 and/or video camera 148 can be implemented as a number of different sensors depending on a particular application. For example, video camera 148 may include a first sensor being a depth sensor detector, and a second sensor being a color-image sensor (e.g., RGB, YUV). In other examples, image sensor 140 may include a first sensor configured for capturing an image signal (e.g., color image sensor, depth-enabled image sensing (RGDB), stereo camera (L/R RGB), or YUV) and a second sensor configured to capture image data different from the first image sensor. The embodiments are not limited in this context.

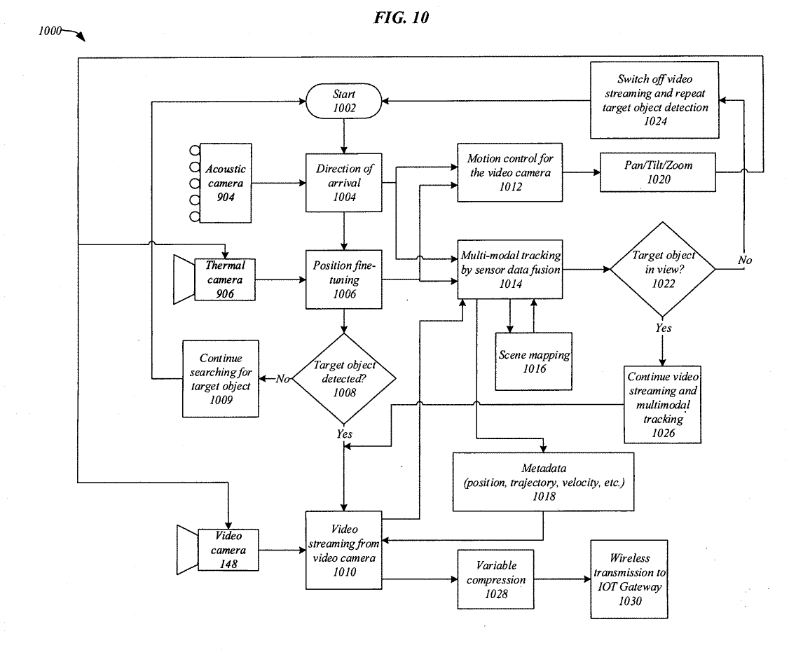

The data acquisition device 112 may include a thermal sensor 144. Thermal sensor 144 may be implemented as any type of sensor capable of detecting thermal energy and converting it into proportional electrical signals including, for example CMOS, CCD and hybrid CCD/CMOS sensors. Some such example sensors include, for instance, infrared signals, x-rays, ultra-violet signals, and the like. Although a single thermal sensor 144 is depicted in FIG. 10, it should be appreciated additional sensors and sensor types can be utilized (e.g. multiple thermal cameras arranged to image a scene of a defined physical space from different perspectives) without departing from the scope of the present disclosure. To this end, thermal sensor 144 can be implemented as a number of different sensors depending on a particular application. For example, thermal sensor 144 may include a stereo thermal camera. In the illustrated embodiment, the thermal sensor 110 may be attached with video camera 148 to motorized mount 152. In other embodiments, the video camera 148 and the thermal sensor 110 may be attached to separate motorized mount. In either case, by attaching the thermal sensor 110 to the motorized mount 152, its FOV to be directed to any location within the defined physical space 104.

Referring again to FIG. 8, acoustic images 206 and thermal images 404 can be generated by the acoustic component 118 and the thermal component 124 respectively, based on signals 114, 202, 116 received by the multimodal object tracking application 110 from the data acquisition device 112. These images 206, 404 may be received by the analysis component 130 in order to identify the origin point 132 of the target object 102 in the defined physical space 104. Once an origin point 132 for the target object 102 has been identified tracking operations can be initiated. The embodiments are not limited in this context.

Tracking operations may be initiated by causing video camera 148 to begin sending video signals 802 to the video camera control component 804 and/or the analysis component 130. Based on the video signals 802, the video camera control component 804 may generate a video image 806 and associated metadata 808. Metadata 808 can include basic information about a target object 102 such as position, trajectory, velocity, and the like. Additionally the video camera control component 804 may control one or more video camera parameters 810. In some embodiments, the video image 806 and/or metadata 808 may be sent to the analysis component 130.

The analysis component 130 may access and/or store metadata 816 and a data acquisition device reset 826. In various embodiments data acquisition device reset 826 may enable the enable data acquisition devices 112 to be set to an initial state (e.g. only the microphone array 106 and images sensor 114 are operating to identify objects within the defined physical space 104). The metadata 816 may include information regarding the target object 102 such as origin point 132, location information 818, tracking information 820, trackability 822, and priority level 824. The embodiments are not limited in this context.

The origin point 132 may identify the location from which a target object 102 is identified and tracked. Location information 818 may include the locations of sound objects 120, thermal objects 126, and/or target objects 102 as determined by the acoustic and/or thermal components 118, 124. In some embodiments the location information 818 may include one or more acoustic or thermal images 206, 404. In various embodiments origin point 132 may be included in location information 818.

Trackability 822 may indicate how close a target object 102 is to exiting the defined physical space 104. In some embodiments data acquisition device reset 826 may be utilized when a target object exits the defined physical space 104. Tracking information 820 may include position updates for a target object 102. In some embodiments, position updates are stored as a direction and magnitude a target object 102 has moved from the associated origin point 132 from which tracking operations began. In various embodiments tracking information 820 may record movement history of a target object 102. In various such embodiments, movement of the target object 102 can be retraced or reviewed based on tracking in formation 820.

Based on the data (e.g., video image, video image metadata, acoustic images, thermal images, etc.) received from various components of the object tracking apparatus 100 or generated/stored (e.g., metadata 816) by the analysis component 130, the analysis component 130 may assign a priority level 825 to a target object 102. For instance, a target object 102 that is moving rapidly or erratically within the defined physical space 104 may be assigned a higher priority level than a stationary or slow moving target object 102. In another example, the trackability 822 of the target object 102 may decrease the priority level 824 associated with a target object 102 when the analysis component 130 determines the target object 102 is close to the boundaries of the defined physical space 104.

In some embodiments the video camera control component 804 may receive data from the analysis component 130 such as origin point 132, location information 818 or tracking information 820. Based on the received data, the video camera control component 804 may issue one or more video camera and/or motorized mount control directives 812,814 to maintain the target object 102 within the FOV of video camera 148 or adjust video camera parameters 810. For instance, video camera parameters 810 may be dynamically adjusted based on the priority level 824 assigned to a target object 102. The video camera parameters 810 may include one or more of the following level of video compression, frame rate, focus, image quality, angle, pan, tilt, zoom, image capture parameters, image processing parameters, power mode, and the motorized mount 152. The dynamic adjustments may result from video camera and/or motorized mount control directives 814 issued by the video camera control component. In various embodiments dynamic adjustment of video camera parameters 810 can decrease processing and power demands on the object tracking apparatus 100. For example, a lower level of video compression (i.e., lower loss) may be used for a target object with a high priority level, while a higher level (i.e., higher loss) may be used for a target object 102 with a lower priority level.

As described herein, one or more settings or parameters of the apparatus 100 may be dynamically adjusted. In various such embodiments, the parameters may be determined, at least in part, based on data of activity within the predefined physical space 104 and/or priority level. This data may include a history of activity in the defined physical space 104 as recorded by one or more of data acquisition device 112. In some embodiments, the apparatus 100 may apply machine learning algorithms to the activity data to update the parameters.

FIGS. 9A-D illustrate an exemplary embodiment of identifying and tracking a target object 102 with an object tracking apparatus 900 by selectively utilizing one or more modalities of object detection. In these embodiments, utilization of a modality can be identified by whether or not corresponding FOV lines appear in the respective figure. In some embodiments, when a modality is not being utilized it is powered off. Further, with respect to FIGS. 9A-D, acoustic camera 904 is described in place of the microphone array 136 and/or image sensor 140 and a thermal camera 906 is described in place of thermal sensor 144. As may be appreciated, the object tracking apparatus 100 may function the same or similar to object tracking apparatus 900 and one or more components of apparatus 100 and 900 may be interchangeable. The embodiments are not limited in this context.

FIG. 9A illustrates an object tracking apparatus 900 operating in an initial state for monitoring a defined physical space 104. The initial state may employ a single modality of object detection for approximating a location of an object of interest 920. During the initial state, the object tracking apparatus 900 may operate in a reduced power mode. The reduced power mode may comprise utilizing a single modality available to the apparatus 100 for identifying an object of interest 920. In some embodiments, the single modality may utilize acoustic camera 904 with FOV 138. As an object of interest 920 enters the defined physical space 104, the acoustic camera may detect sound energy arriving approximately from the location of object of interest 920. For instance, the acoustic camera 904 may detect the footsteps of a person walking. Based on the detected sound energy associated with object of interest 920, an approximate location for the object of interest 920 may be determined.

In various embodiments the initial state may start with aligning the motorized mount 152 with a predefined or determined point in the defined physical space such as the center. In various such embodiments, the initial alignment point may be dynamically adjusted based on previous activity within the defined physical space 104.

FIG. 9B illustrates object tracking apparatus 900 operating in a location refinement state. The location refinement state may employ a second modality of object detection to refine the location of the object of interest 120. In some embodiments the second modality may utilize thermal camera 906. For instance, during the location refinement state, motorized mount 152 may receive control directives to direct the thermal camera 906 FOV 146 at the approximate location of object of interest 920. As shown in FIG. 9B the motorized mount rotates counter-clockwise to position the object of interest 920 within the thermal FOV 146. Once the motorized mount is appropriately positioned, the object tracking system 100 may activate thermal camera 906 as the second modality of object detection. Activation of the thermal camera 906 can be used to improve the accuracy of the location of the object of interest 920 as described above, this is represented in FIG. 9B by a decrease in the size on the object of interest 920 with respect to FIG. 9A.

FIG. 9C illustrates object tracking apparatus 900 operating in a target object identification state. The target object identification state may employ a third modality of object detection to identify, classify, and/or prioritize the target object 102. Once the thermal camera 906 acquires the object of interest 120 and refines the location of the object of interest 920, the objeCt tracking apparatus 900 may identify the object of interest 920 as target object 102. The apparatus 900 may then make fine adjustments to motorized mount 152 to position the target object 102 within the video FOV 150. Once the motorized mount 152 is in position, video camera 148 may be activated. The video camera 148 may be activated to record high resolution images of the target object 102.

The apparatus 900 may identify and/or classify the target object 102 based on input from one or more of the acoustic, thermal, and video cameras 904, 906, 148. In various embodiments, the target object 102 may be assigned one more classification to provide context. This context may enable the apparatus 900 to determine one or more parameters associated with monitoring the target object 102. These classifications may include things such as type, subtype, activity, velocity, acceleration, familiarity, authorization, and the like. In various such embodiments a priority level may be assigned to the target object 102 based on the associated classifications. One or more tracking operations may be adjusted according to the priority level, such as the resolution, frame rate, or power state of one or more sensors of the apparatus 900.

For instance, the target object 102 may be classified as a person walking in the defined physical space 104. In some embodiments the apparatus 900 may employ facial recognition to further classify the person walking as a known employee that is authorized to be within the defined physical space 104. Based on these classifications the employee may be assigned a low priority level. The low priority level may cause the apparatus 900 to monitor the activity of the employee with video camera 148 set to a low resolution.

In some embodiments, components of a target object 102 may be identified. For example, the apparatus 900 may identify the target object 102 as a person carrying a weapon. Accordingly the person carrying the weapon may be assigned a high priority. The high priority level may cause the apparatus to monitor the activity of the armed person with video camera 148 set to a high resolution.

FIG. 9D illustrates object tracking apparatus 900 operating in a target object tracking state. In the target object tracking state, acoustic camera 904, thermal camera 906, and video camera 148 may be powered on. As the target object moves through the defined physical space 104, the motorized mount 152 may rotate clockwise. This rotation may be a result of tracking operations performed by the apparatus 100. These tracking operations may include updating a position of the target object 102 at a predetermined rate (e.g., 0.5 Hz, 1 Hz, 10 Hz, etc.) based on data collected on the target object 102. For instance, when the target object 102 is a person with a weapon walking across the defined physical space 104, the location of the armed person may be updated at 120 Hz. In some embodiments the apparatus 900 may be able to track a projectile traversing the defined physical space 104, such as a bullet originating from the weapon of the armed person. In these embodiments the position of target objects 102 may be updated thousands of times a second (e.g. 120,000 Hz). In various embodiments an object such as the projectile may be tracked without repositioning the motorized mount 152. In various such embodiments, only sensors with FOVs that cover the entire defined physical space 104, such as acoustic FOV 138, may be utilized for identification and tracking operations.

As may be appreciated the states described with respect to FIGS. 9A-D may be executed in any order or manner, such as in parallel, to effectively monitor objects. For example, the apparatus 900 may identify, classify, and track a multitude of objects within the defined physical space 104 based on their respective priority levels. In another example, a target object 102 may simultaneously be classified and tracked. In a further example, a target object may only be identified and tracked while it is within the defined physical space with classifications may being assigned only after the target object has exited the defined physical space 104.

FIG. 10 illustrates an example process flow of identifying and tracking a target object. The process flow may start at block 1002. At block 1004 it may determine an approximate direction of arrival (DOA) based on signals received from acoustic camera 904. Based, at least in part, on the direction of arrival an approximate location for an object of interest may be determined. In some embodiments this determination is made by the acoustic component 118 and/or analysis component 130.

In various embodiments, once an object of interest has been approximately located, both the thermal camera 906 and the video camera 148 are pointed towards the DOA. The position of the object of interest may be fined tuned at block 1006 based on signals received from thermal camera 906. In some embodiments this determination is made by the thermal component 124 and/or analysis component 130. At block 1008 it may be a determination of whether the object of interest is a target object may be made. If a target object was not identified, at block 1009 the search for a target object may continue by returning to the start 1002. When a target object is identified, video streaming is initiated based on signals received from video camera 148. In various embodiments, the video streaming may include metadata such as position, trajectory, velocity, etc. as shown in block 1018.

At block 1012 motion control for the video camera is planned (e.g., motorized mount control directives 814 are generated. At block 1020 the pan, tilt, and/or zoom of video camera 148 is adjusted. At block 1014, multi-modal tracking by sensor data fusion occurs. This can include scene mapping 1016 and generating metadata for the video stream at block 1018. In some embodiments all three signal sources may be utilized to perform image processing or tracking operations such as Kalman filtering and/or blob detection. At the same time the apparatus may store the most prevalent locations of the object. This information may be used to bias the initial position of the video and thermal cameras 148, 906 whenever an object is lost. In some embodiments these operations apply one or more simultaneous location and mapping (SLAM) techniques.

Further a determination of whether the target object is in view may be made at block 1022. If the target object is not in view, at block 1024, the video stream may be turned off and target object detection may be repeated by returning to the start at block 1002. When the target object is in view, video streaming and multimodal tracking may be continued at block 1026. At block 1028, the video may be streamed with variable compression rates. In various embodiments the video is streamed over the internes to a remote terminal. In various such embodiments, the video may be streamed to a user via a computing device with a user interface. In some embodiments determination of the compression rate can be based on a priority level assigned to the target object. At block 1030 the video stream may be wirelessly transmitted to an interne of things (IOT) gateway. The IOT gateway may enable distributed, collaborated, and/or federated deployments of object identification and tracking systems.

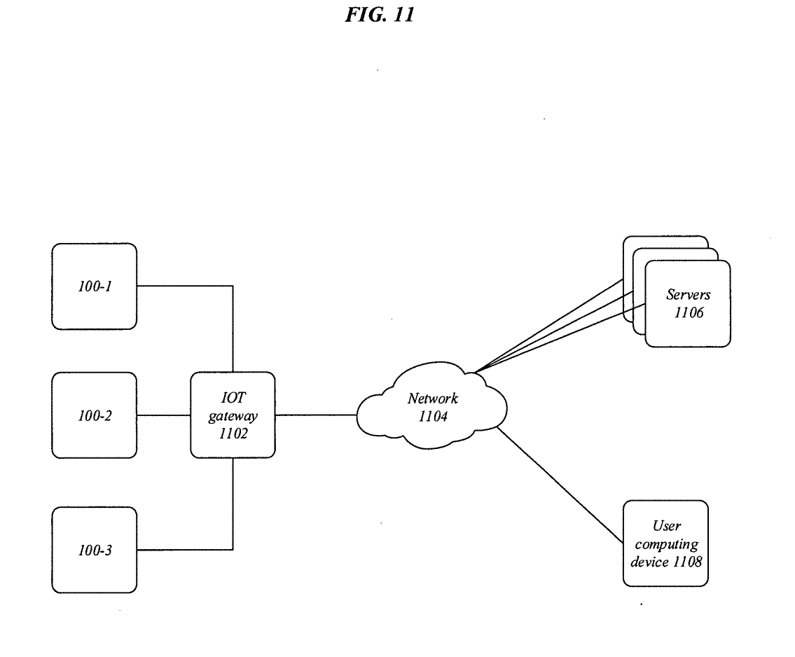

FIG. 11 illustrates an embodiment of a set of object tracking apparatuses 100-1, 100-2, 100-3 connected to an IOT gateway 1102. The set of object tracking apparatuses 100 may be referred to as an object tracking system. In some embodiments each object tracking apparatus may have an independent IOT gateway 1102. The IOT gateway 1102 may be communicatively coupled to network 1104. In some embodiments, network 1104 is the internet.

Servers 1106 may receive data (e.g. streaming acoustic, thermal, and/or video signals) for storage, analysis, or distribution from the object tracking apparatuses 100 via network 1104. User computing device 1104 may receive streaming video signals from object tracking apparatuses 100 through network 1104 via IOT gateway 1102. In various embodiments the user computing device 1104 may receive the streaming video signals via requests submitted to one or more servers 1106. Utilization of IOT gateways may allow for simple and efficient scaling of object tracking systems.

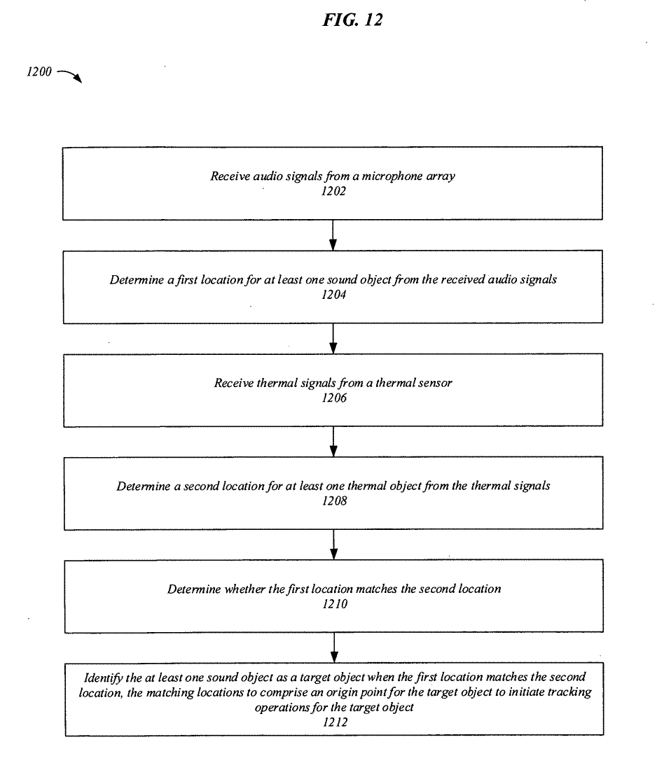

FIG. 12 illustrates one embodiment of a logic flow 1200. The logic flow 1200 may be representative of some or all of the operations executed by one or more embodiments described herein, such as the apparatus 100 or the multimodal object tracking application 110.

In the illustrated embodiment shown in FIG. 12, the logic flow 1200 may receive audio signals from a microphone array at block 1202. At block 1204 a first location for at least one sound object is determined from the received audio signals. For example a projectile traversing a monitored space. Thermal signals may be received from a thermal sensor at block 1206. A second location for at least one thermal object is determined from the thermal signals at block 1208. At block 1210 it may be determined whether the first location matches the second location. For example, sound of footsteps matches the location of a human being heat signature. When the first and second locations match, the matching locations include an origin point for a target object to initiate tracking operations for the target object.

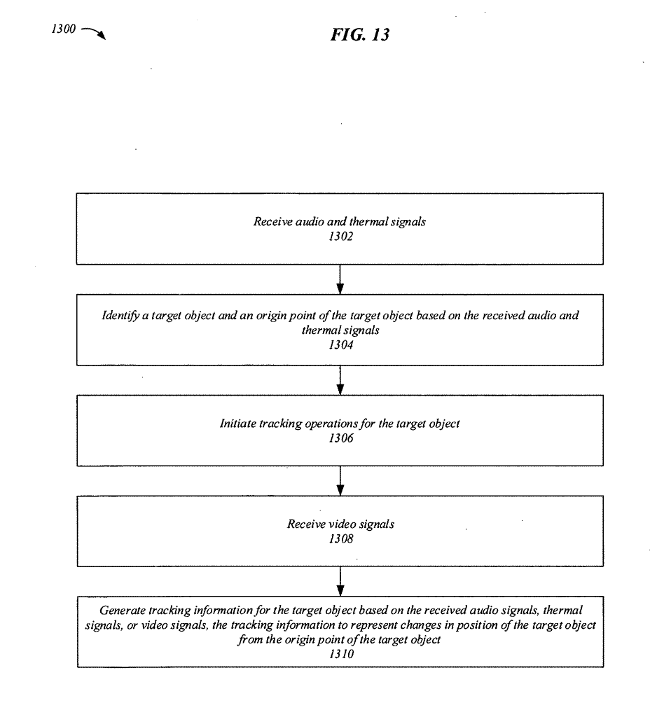

FIG. 13 illustrates one embodiment of a logic flow 1300. The logic flow 1300 may be representative of some or all of the operations executed by one or more embodiments described herein, such as the apparatus 100 or the multimodal object tracking application 110.

In the illustrated embodiment shown in FIG. 13, the logic flow 1300 may receive audio and thermal signals at block 1302. For example, from data acquisition devices. At block 1304 a target object and an origin point for the target object may be identified based on the received audio and thermal signals. At block 1306 tracking operations may be initiated for the target object. Video signals may be received at block 1308 while at block 1310 tracking information may be generated for the target object based on the receive audio signals, thermal signals, or video signals. The tracking information to represent changes in position of the target object from the origin point of the target object.

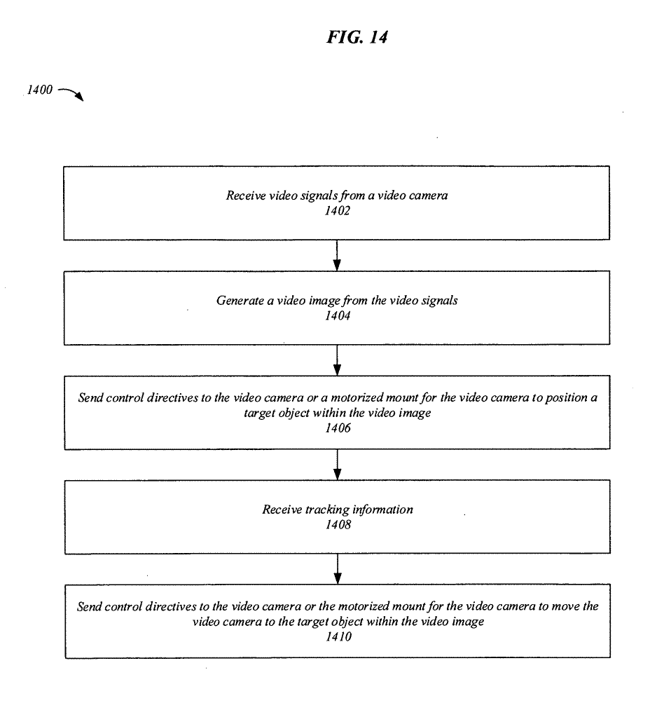

FIG. 14 illustrates one embodiment of a logic flow 1400. The logic flow 1400 may be representative of some or all of the operations executed by one or more embodiments described herein, such as the apparatus 100 or the multimodal object tracking application 110.

In the illustrated embodiment shown in FIG. 14, the logic flow 1400 may receive video signals from a video camera at block 1402. At block 1404 a video image may be generated from the video signals. Control directives may be sent to the video camera or motorized mount for the video camera to position a target object within the video image at block 1406. Tracking information may be received at block 1408. At block 1410 control directives may be sent to the video camera or motorized mount for the video camera to move the video camera to the target object within the video image. In some embodiments a thermal camera or sensor may utilize the same motorized mount.

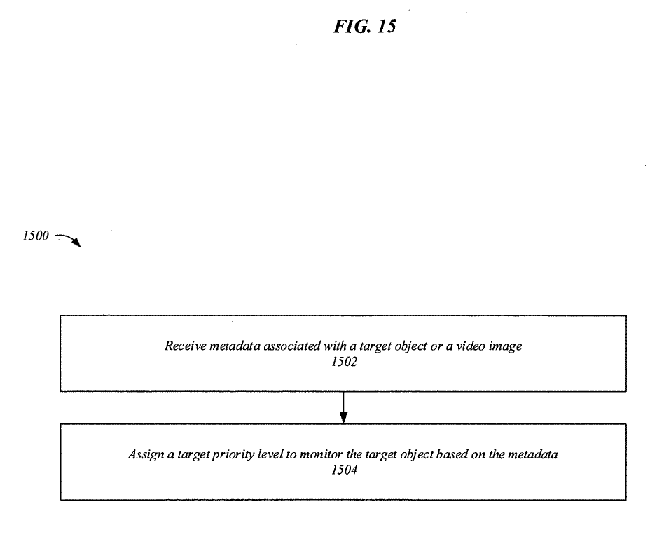

FIG. 15 illustrates one embodiment of a logic flow 1500. The logic flow 1500 may be representative of some or all of the operations executed by one or more embodiments described herein, such as the apparatus 100 or the multimodal object tracking application 110.

In the illustrated embodiment shown in FIG. 15, the logic flow 1500 may receive metadata associated with a target object or a video image at block 1502. A target priority level may be assigned to the target object based on the metadata at block 1504.

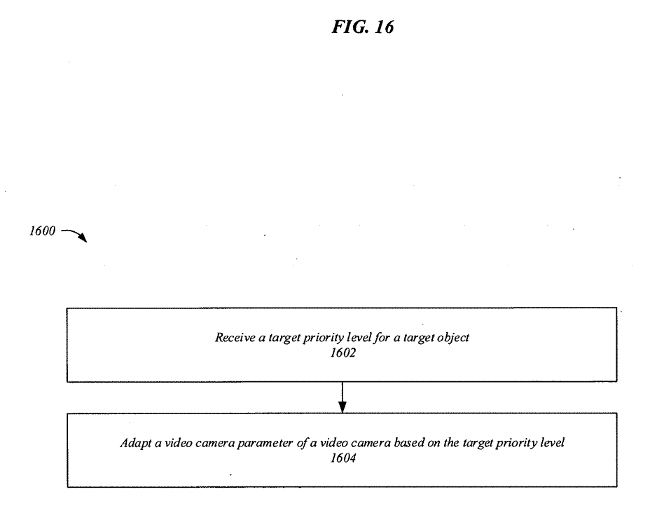

FIG. 16 illustrates one embodiment of a logic flow 1600. The logic flow 1600 may be representative of some or all of the operations executed by one or more embodiments described herein, such as the apparatus 100 or the multimodal object tracking application 110.

In the illustrated embodiment shown in FIG. 16, the logic flow 1600 may receive a target priority level for a target object at block 1602. A video camera parameter of a video camera may be adapted based on the target priority level at block 1604.

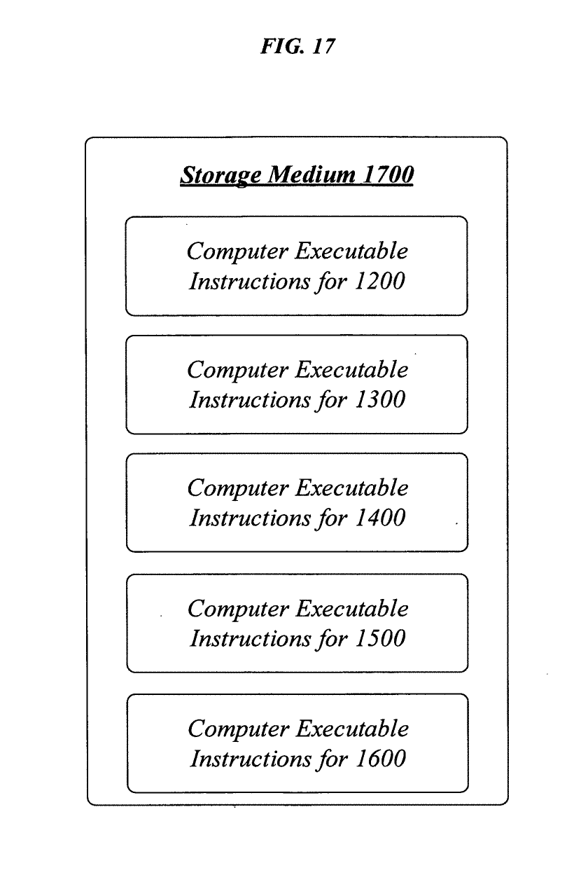

FIG. 17 illustrates an embodiment of a storage medium 1700. Storage medium 1700 may comprise any non-transitory computer-readable storage medium or machine-readable storage medium, such as an optical, magnetic or semiconductor storage medium. In various embodiments, storage medium 1700 may comprise an article of manufacture. In some embodiments, storage medium 1700 may store computer-executable instructions, such as computer-executable instructions to implement one or more of process or logic flows 1000, 1200, 1300, 1400, 1500, 1600 of FIGS. 10 and 12-16. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

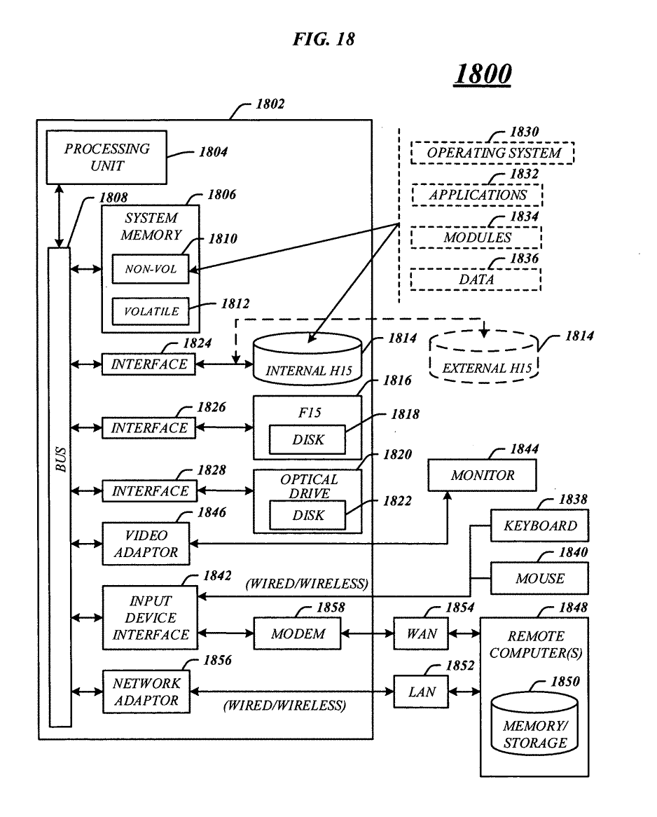

FIG. 18 illustrates an embodiment of an exemplary computing architecture 1800 that may be suitable for implementing various embodiments as previously described. In various embodiments, the computing architecture 1800 may comprise or be implemented as part of an electronic device. In some embodiments, the computing architecture 1800 may be representative, for example, of a processor or server that implements one or more components of the object tracking apparatus 100. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 1800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1800.

As shown in FIG. 18, the computing architecture 1800 comprises a processing unit 1804, a system memory 1806 and a system bus 1808. The processing unit 1804 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1804.

The system bus 1808 provides an interface for system components including, but not limited to, the system memory 1806 to the processing unit 1804. The system bus 1808 can be any of several types of bus structure that may further interconnect to a memory bus (with or without a memory controller), a peripheral bus, and a local bus using any of a variety of commercially available bus architectures. Interface adapters may connect to the system bus 1808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 1806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 18, the system memory 1806 can include non-volatile memory 1810 and/or volatile memory 1812. A basic input/output system (BIOS) can be stored in the non-volatile memory 1810.

The computer 1802 may include various types of computer-readable storage media in the form of one or more lower speed memory units, including an internal (or external) hard disk drive (HDD) 1814, a magnetic floppy disk drive (FDD) 1816 to read from or write to a removable magnetic disk 1818, and an optical disk drive 1820 to read from or write to a removable optical disk 1822 (e.g., a CD-ROM or DVD). The HDD 1814, FDD 1816 and optical disk drive 1820 can be connected to the system bus 1808 by a HDD interface 1824, an FDD interface 1826 and an optical drive interface 1828, respectively. The HDD interface 1824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1810, 1812, including an operating system 1830, one or more application programs 1832, other program modules 1834, and program data 1836. In one embodiment, the one or more application programs 1832, other program modules 1834, and program data 1836 can include, for example, the various applications and/or components of the system 100.

A user can enter commands and information into the computer 1802 through one or more wire/wireless input devices, for example, a keyboard 1838 and a pointing device, such as a mouse 1840. Other input devices may include microphones, infra-red (IR) remote controls, radio-frequency (RF) remote controls, game pads, stylus pens, card readers, dongles, finger print reader's, gloves, graphics tablets, joysticks, keyboards, retina readers, touch screens (e.g., capacitive, resistive, etc.), trackballs, trackpads, sensors, styluses, and the like. These and other input devices are often connected to the processing unit 1804 through an input device interface 1842 that is coupled to the system bus 1808, but can be connected by other interfaces such as a parallel port, IEEE 1394 serial port, a game port, a USB port, an IR interface, and so forth.

A monitor 1844 or other type of display device is also connected to the system bus 1808 via an interface, such as a video adaptor 1846. The monitor 1844 may be internal or external to the computer 1802. In addition to the monitor 1844, a computer typically includes other peripheral output devices, such as speakers, printers, and so forth.

The computer 1802 may operate in a networked environment using logical connections via wire and/or wireless communications to one or more remote computers, such as a remote computer 1848. The remote computer 1848 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory/storage device 1850 is illustrated. The logical connections depicted include wire/wireless connectivity to a local area network (LAN) 1852 and/or larger networks, for example, a wide area network (WAN) 1854. Such LAN and WAN networking environments are commonplace in offices and companies, and facilitate enterprise-wide computer networks, such as intranets, all of which may connect to a global communications network, for example, the Internet.

When used in a LAN networking environment, the computer 1802 is connected to the LAN 1852 through a wire and/or wireless communication network interface or adaptor 1856. The adaptor 1856 can facilitate wire and/or wireless communications to the LAN 1852, which may also include a wireless access point disposed thereon for communicating with the wireless functionality of the adaptor 1856.

When used in a WAN networking environment, the computer 1802 can include a modem 1858, or is connected to a communications server on the WAN 1854, or has other means for establishing communications over the WAN 1854, such as by way of the Internet. The modem 1858, which can be internal or external and a wire and/or wireless device, connects to the system bus 1808 via the input device interface 1842. In a networked environment, program modules depicted relative to the computer 1802, or portions thereof, can be stored in the remote memory/storage device 1850. It will be appreciated that the network connections shown are exemplary and other means of establishing a communications link between the computers can be used.

The computer 1802 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

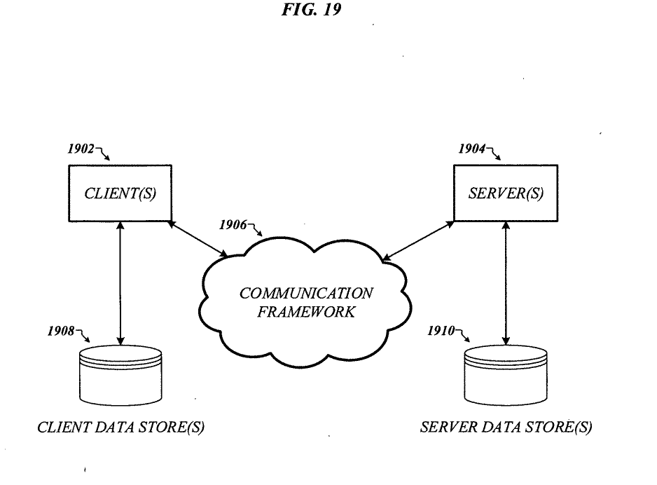

FIG. 19 illustrates a block diagram of an exemplary communications architecture 1900 suitable for implementing various embodiments as previously described. The communications architecture 1900 includes various common communications elements, such as a transmitter, receiver, transceiver, radio, network interface, baseband processor, antenna, amplifiers, filters, power supplies, and so forth. The embodiments, however, are not limited to implementation by the communications architecture 1900.

As shown in FIG. 19, the communications architecture 1900 comprises includes one or more clients 1902 and servers 1904. The clients 1902 and the servers 1904 are operatively connected to one or more respective client data stores 1908 and server data stores 1910 that can be employed to store information local to the respective clients 1902 and servers 1904, such as cookies and/or associated contextual information. In various embodiments, any one of servers 1904 may implement one or more of logic flows 1000, 1200-1700 of FIGS. 10, 12-16, and storage medium 1700 of FIG. 17 in conjunction with storage of data received from any one of clients 1902 on any of server data stores 1910.

The clients 1902 and the servers 1904 may communicate information between each other using a communication framework 1906. The communications framework 1906 may implement any well-known communications techniques and protocols. The communications framework 1906 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1906 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1902 and the servers 1904. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments, from which numerous permutations and configurations will be apparent.

Example 1 is apparatus comprising logic, logic, at least a portion of which is implemented in hardware, the logic comprising a multimodal object tracking application to track a target object within a scene of a defined physical space. The multimodal object tracking application comprising acoustic, thermal, and analysis components. The acoustic component to receive audio signals, determine a set of sound objects from the received audio signals, and determine an approximate location for at least one of the sound objects within the defined physical space. The thermal component to receive thermal signals, determine a set of thermal objects from the received thermal signals, and determine an approximate location for at least one of the thermal objects within the defined physical space. The analysis component to receive the approximate locations, determine whether the approximate location for the at least one sound object matches the approximate location for the at least one thermal object, and identify the at least one sound object as the target object when the approximate locations match, the matching approximate locations to comprise an origin point for the target object to initiate tracking operations for the target object.

Example 2 includes the subject matter of Example 1, the multimodal object tracking application further comprising a video camera control component to receive video signals from a video camera, generate a video image from the video signals, and send control directives to the video camera to position the target object within the video image.

Example 3 includes the subject matter of Example 1-2, the multimodal object tracking application further comprising a video camera control component to receive video signals from a video camera, generate a video image from the video signals, and send control directives to a motorized mount for the video camera to move the video camera to position the target object within the video image.

Example 4 includes the subject matter of Examples 1-3, the analysis component to receive the video signals, the analysis component to generate tracking information for the target object based on the received audio signals, thermal signals or video signals, the tracking information to represent changes in position of the target object from the origin point of the target object, and output the tracking information.

Example 5 includes the subject matter of Examples 2-4, the video camera control component to receive tracking information, and send control directives to the video camera to keep the target object within the video image

Example 6 includes the subject matter of Example 2-5, the video camera control component to receive tracking information, and send control directives to the motorized mount for the video camera to move the video camera to keep the target object within the video image.

Example 7 includes the subject matter of Example 2-6, the video camera control component to control a level of video compression of the video signals received from the video camera.

Example 8 includes the subject matter of Example 2-7, the analysis component to receive metadata associated with the target object or the video image, assign a target priority level to monitor the target object based on the metadata, and output the target priority level to the video camera control component.

Example 9 includes the subject matter of Examples 2-8, the video camera control component to receive a target priority level for the target object, and dynamically adapt a video camera parameter of the video camera based on the target priority level, the video camera parameter to comprise a level of video compression, a frame rate for the video camera, a focus for the video camera, image quality for the video camera, an angle of the video camera, a pan of the video camera, a tilt of the video camera, a zoom level of the video camera, an image capture parameter for the video camera, an image processing parameter for the video camera, a power mode for the video camera, or a motorized mount for the video camera.

Example 10 includes the subject matter of Examples 2-9, the video camera control component to receive a target priority level for the target object, and dynamically adapt a level of video compression of the video signals received from the video camera based on the target priority level.

Example 11 includes the subject matter of Examples 2-10, the video camera control component to select a level of video compression of the video signals received from the video camera based on a target priority level, and send a control directive with the selected level of video compression to the video camera.

Example 12 includes the subject matter of Examples 2-11, the video camera control component to select a level of video compression of the video signals received from the video camera based on a target priority level, set a lower level of compression for a higher target priority level, and set a higher level of compression for a lower target priority level.

Example 13 includes the subject matter of Examples 2-12, the analysis component to store location information for the target object.

Example 14 includes the subject matter of Examples 2-13, the analysis component to determine the target object is no longer within tracking range.

Example 15 includes the subject matter of Example 12, the analysis component to send a reset signal to one or more data acquisition devices to place the one or more data acquisition devices in an initial state.

Example 16 includes the subject matter of Examples 2-15, the apparatus comprising a communications interface to send the video signals to a remote device over a network.

Example 17 includes the subject matter of Examples 1-16, the acoustic component to comprise a computer audio vision controller to receive as input audio signals and image signals, generate an acoustic image based on the received audio signals and the received image signals, the acoustic image to include the at least one sound object within the acoustic image, and output the acoustic image.

Example 18 includes the subject matter of Example 17, the computer audio vision controller to comprise part of an acoustic camera.

Example 19 includes the subject matter of Examples 17-18, the acoustic image to comprise a visual representation of sound energy in a scene of the defined physical space.

Example 20 includes the subject matter of Examples 17-19, the acoustic image to represent an image of the defined physical space at a given moment in time, the acoustic image to comprise a multi-dimensional set of pixels, wherein each pixel represents a level of sound energy.

Example 21 includes the subject matter of Examples 17-20, the computer audio vision controller to select a sub-set of pixels from a set of pixels of the acoustic image, and generate a sound energy value for the sub-set of pixels.

Example 22 includes the subject matter of Examples 17-21, the computer audio vision controller to determine when a sound energy value for a sub-set of pixels is greater than or equal to a sound energy threshold, and identify the sub-set of pixels as the at least one sound object.

Example 23 includes the subject matter of Examples 1-22, the thermal component to comprise a thermal image component to receive as input thermal signals, generate a thermal image based on the received thermal signals, the thermal image to include the at least one thermal object within the thermal image, and output the thermal image.

Example 24 includes the subject matter of Example 23, the thermal image to comprise a visual representation of thermal energy in a scene of the defined physical space.

Example 25 includes the subject matter of Examples 23-24, the thermal image to comprise a multi-dimensional set of pixels, wherein each pixel represents a level of thermal energy.

Example 26 includes the subject matter of Examples 23-25, the thermal controller to select a sub-set of pixels from a set of pixels of the thermal image, and generate a temperature value for the sub-set of pixels.

Example 27 includes the subject matter of Example 26, the thermal controller to determine when a temperature value for a sub-set of pixels is greater than or equal to a temperature threshold, and identify the sub-set of pixels as the at least one thermal object.

Example 28 includes the subject matter of Example 27, the temperature threshold to represent a heat signature for a human being.

Example 29 includes the subject matter of Examples 26-27, the thermal controller to determine when a temperature value for a sub-set of pixels is lesser than or equal to a temperature threshold, and identify the sub-set of pixels as not the at least one thermal object.

Example 30 includes the subject matter of Example 29, the temperature threshold to represent a heat signature for a non-human object.

Example 31 includes the subject matter of Examples 1-30 the analysis component to comprise an image analysis component to receive an acoustic image and a thermal image, determine whether the approximate location for the at least one sound object from the acoustic image matches the approximate location for the at least one thermal object from the thermal image, and identify the at least one sound object as the target object when the approximate locations match.

Example 32 includes the subject matter of Examples 1-31, the multimodal object tracking application to comprise a microphone control component to control direction of an acoustic beam formed by a microphone array, the microphone control component to receive the location for the target object from the analysis component, and send control directives to the microphone array to steer the acoustic beam towards the location for the target object.

Example 33 includes the subject matter of Examples 1-32, the logic implemented as part of a system-on-chip (SOC).

Example 34 includes the subject matter of Example 1-33, the logic implemented as part of a mobile computing device comprising a wearable device, a smartphone, a tablet, or a laptop computer.

Example 35 includes the subject matter of Examples 1-34, comprising multiple data acquisition devices communicatively coupled to the logic, the multiple data acquisition devices to include a microphone array, an image sensor, a video camera, or a thermal sensor.

Example 36 includes the subject matter of Examples 1-35, comprising a microphone array communicatively coupled to the logic, the microphone array to convert acoustic pressures froth the defined physical space to proportional electrical signals, and output the proportional electrical signals as audio signals to the computer audio vision controller.

Example 37 includes the subject matter of Examples 1-36, comprising a microphone array communicatively coupled to the logic, the microphone array comprising a directional microphone array arranged to focus on a portion of the defined physical space.

Example 38 includes the subject matter of Examples 1-37, comprising a microphone array communicatively coupled to the logic, the microphone array comprising an array of microphone devices, the array of microphone devices comprising at least one of a unidirectional microphone type, a bi-directional microphone type, a shotgun microphone type, a contact microphone type, or a parabolic microphone type.

Example 39 includes the subject matter of Examples 1-38, comprising an image sensor communicatively coupled to the logic, the image sensor to convert light from the defined physical space to proportional electrical signals, and output the proportional electrical signals as image signals to the computer audio vision controller.

Example 40 includes the subject matter of Examples 1-39, comprising one or more thermal sensors communicatively coupled to the logic, the one or more thermal sensors to convert heat to proportional electrical signals, and output the proportional electrical signals as thermal signals to the thermal image controller.

Example 41 includes the subject matter of Examples 1-40, comprising multiple data acquisition devices communicatively coupled to the logic, the multiple data acquisition devices having spatially aligned capture domains.

Example 42 is a computer-implemented method, comprising receiving audio signals from a microphone array, determining a first location for at least one sound object from the received audio signals, receiving thermal signals from a thermal sensor, determining a second location for at least one thermal object from the thermal signals, determining whether the first location matches the second location, and identifying the at least one sound object as a target object when the first location matches the second location, the matching locations to comprise an origin point for the target object to initiate tracking operations for the target object.

Example 43 includes the subject matter of Example 42, comprising receiving video signals from a video camera, generating a video image from the video signals, and sending control directives to the video camera to position the target object within the video image.

Example 44 includes the subject matter of Example 42-43, comprising receiving video signals from a video camera, generating a video image from the video signals, and sending control directives to a motorized mount for the video camera to move the video camera to position the target object within the video image.

Example 45 includes the subject matter of Examples 43-44, comprising receiving video signals and generating tracking information for the target object based on the received audio signals, thermal signals or video signals, the tracking information to represent changes in position of the target object from the origin point of the target object.

Example 46 includes the subject matter of Example 43-45, comprising receiving tracking information and sending control directives to the video camera to keep the target object within the video image.

Example 47 includes the subject matter of Example 43-46, receiving tracking information and sending control directives to the motorized mount for the video camera to move the video camera to keep the target object within the video image.

Example 48 includes the subject matter of Examples 43-47, comprising controlling a level of video compression of the video signals received from the video camera.

Example 49 includes the subject matter of Examples 45-48, comprising receiving metadata associated with the target object or the video image and assigning a target priority level to monitor the target object based on the metadata.

Example 50 includes the subject matter of Example 43-49, comprising receiving a target priority level for the target object and adapting a video camera parameter of the video camera based on the target priority level, the video camera parameter to comprise a level of video compression, a frame rate for the video camera, a focus for the video camera, image quality for the video camera, an angle of the video camera, a pan of the video camera, a tilt of the video camera, a zoom level of the video camera, an image capture parameter for the video camera, an image processing parameter for the video camera, a power mode for the video camera, or a motorized mount for the video camera.

Example 51 includes the subject matter of Examples 43-50, comprising receiving a target priority level for the target object and adapting a level of video compression of the video signals received from the video camera based on the target priority level.

Example 52 includes the subject matter of Examples 43-51, comprising selecting a level of video compression of the video signals received from the video camera based on a target priority level and sending a control directive with the selected level of video compression to the video camera.

Example 53 includes the subject matter of Examples 43-52, comprising selecting a level of video compression of the video signals received from the video camera based on a target priority level, setting a lower level of compression for a higher target priority level, and setting a higher level of compression for a lower target priority level.

Example 54 includes the subject matter of Examples 43-53, comprising storing location information for the target object.

Example 55 includes the subject matter of Examples 43-54, comprising determining the target object is no longer within tracking range.

Example 56 includes the subject matter of Examples 43-55, comprising sending a reset signal to one or more data acquisition devices to place the one or more data acquisition devices in an initial state.

Example 57 includes the subject matter of Examples 43-56, including instructions to receive the location for the target object and send a control directive to the microphone array to steer an acoustic beam towards the location for the target object.

Example 58 is one or more computer-readable media to store instructions that when executed by a processor circuit causes the processor circuit to receive audio signals from a microphone array, determine a first location for at least one sound object from the received audio signals, receive thermal signals from a thermal sensor, determine a second location for at least one thermal object from the thermal signals, determine whether the first location matches the second location, and identify the at least one sound object as a target object when the first location matches the second location, the matching locations to comprise an origin point for the target object to initiate tracking operations for the target object.

Example 59 includes the subject matter of Example 58, comprising instructions to receive video signals from a video camera, generate a video image from the video signals, and send control directives to the video camera to position the target object within the video image.

Example 60 includes the subject matter of Examples 58-59, comprising instructions to receive video signals from a video camera, generate a video image from the video signals, and send control directives to a motorized mount for the video camera to move the video camera to position the target object within the video image.

Example 61 includes the subject matter of Examples 58-60, comprising instructions to receive video signals and generate tracking information for the target object based on the received audio signals, thermal signals or video signals, the tracking information to represent changes in position of the target object from the origin point of the target object.

Example 62 includes the subject matter of Examples 59-61, comprising instructions to receive tracking information and send control directives to the video camera to keep the target object within the video image.

Example 63 includes the subject matter of Examples 59-62, comprising instructions to receive tracking information and send control directives to the motorized mount for the video camera to move the video camera to keep the target object within the video image.

Examples 64 includes the subject matter of Examples 59-63, comprising instructions to control a level of video compression of the video signals received from the video camera.

Examples 65 includes the subject matter of Examples 59-64, comprising instructions to receive metadata associated with the target object or the video image and assign a target priority level to monitor the target object based on the metadata.

Example 66 includes the subject matter of Examples 59-65, comprising instructions to receive a target priority level for the target object and adapt a video camera parameter of the video camera based on the target priority level, the video camera parameter to comprise a level of video compression, a frame rate for the video camera, a focus for the video camera, image quality for the video camera, an angle of the video camera, a pan of the video camera, a tilt of the video camera, a zoom level of the video camera, an image capture parameter for the video camera, an image processing parameter for the video camera, a power mode for the video camera, or a motorized mount for the video camera.

Example 67 includes the subject matter of Examples 59-66, comprising instructions to receive a target priority level for the target object and adapt a level of video compression of the video signals received from the video camera based on the target priority level.

Example 68 includes the subject matter of Examples 59-67, comprising instructions to select a level of video compression of the video signals received from the video camera based on a target priority level and send a control directive with the selected level of video compression to the video camera.

Example 69 includes the subject matter of Examples 59-68, comprising instructions to select a level of video compression of the video signals received from the video camera based on a target priority level, set a lower level of compression for a higher target priority level, and set a higher level of compression for a lower target priority level.

Example 70 includes the subject matter of Examples 59-69, comprising instructions to store location information for the target object.

Example 71 includes the subject matter of Examples 59-70, comprising instructions to determine the target object is no longer within tracking range.

Example 72 includes the subject matter of Examples 59-71, comprising instructions to send a reset signal to one or more data acquisition devices to place the one or more data acquisition devices in an initial state.

Example 73 includes the subject matter of Examples 59-72, comprising instructions to send the video signals to a remote device over a network.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. An apparatus, comprising:
logic, at least a portion of which is implemented in hardware, the logic comprising a multimodal object tracking application to track a target object within a scene of a defined physical space, the multimodal object tracking application comprising:
an acoustic component to receive audio signals, determine a set of sound objects from the received audio signals, and determine an approximate location for at least one of the sound objects within the defined physical space;
a thermal component to receive thermal signals, determine a set of thermal objects from the received thermal signals, and determine an approximate location for at least one of the thermal objects within the defined physical space; and
an analysis component to receive the approximate locations, determine whether the approximate location for the at least one sound object matches the approximate location for the at least one thermal object, and identify the at least one sound object as the target object when the approximate locations match, the matching approximate locations to comprise an origin point for the target object to initiate tracking operations for the target object.

2. The apparatus of claim 1, the multimodal object tracking application to comprise a video camera control component to receive video signals from a video camera, generate a video image from the video signals, and send control directives to the video camera or a motorized mount for the camera to position the target object within the video image.

3. The apparatus of claim 2, the analysis component to receive the video signals, the analysis component to generate tracking information for the target object based on the received audio signals, thermal signals or video signals, the tracking information to represent changes in position of the target object from the origin point of the target object, and output the tracking information.

4. The apparatus of claim 2, the video camera control component to receive tracking information, and send control directives to the video camera or the motorized mount for the video camera to keep the target object within the video image.

5. The apparatus of claim 2, the video camera control component to control a level of video compression of the video signals received from the video camera.

6. The apparatus of claim 2, the analysis component to receive metadata associated with the target object or the video image, assign a target priority level to monitor the target object based on the metadata, and output the target priority level to the video camera control component.

7. The apparatus of claim 2, the video camera control component to receive a target priority level for the target object, and dynamically adapt a video camera parameter of the video camera based on the target priority level, the video camera parameter to comprise a level of video compression, a frame rate for the video camera, a focus for the video camera, image quality for the video camera, an angle of the video camera, a pan of the video camera, a tilt of the video camera, a zoom level of the video camera, an image capture parameter for the video camera, an image processing parameter for the video camera, a power mode for the video camera, or a motorized mount for the video camera3

8. A computer-implemented method, comprising:
receiving audio signals from a microphone array;
determining a first location for at least one sound object from the received audio signals;
receiving thermal signals from a thermal sensor;
determining a second location for at least one thermal object from the thermal signals;
determining whether the first location matches the second location; and
identifying the at least one sound object as a target object when the first location matches the second location, the matching locations to comprise an origin point for the target object to initiate tracking operations for the target object.

9. The computer-implemented method of claim 8, comprising:
receiving video signals from a video camera;
generating a video image from the video signals; and
sending control directives to the video camera or a mount for the video camera to position the target object within the video image.

10. The computer-implemented method of claim 9, comprising:
receiving a target priority level for the target object; and
adapting a level of video compression of the video signals received from the video camera based on the target priority level.

11. The computer-implemented method of claim 9, comprising:
selecting a level of video compression of the video signals received from the video camera based on a target priority level; and
sending a control directive with the selected level of video compression to the video camera.

12. The computer-implemented method of claim 9, comprising:
selecting a level of video compression of the video signals received from the video camera based on a target priority level;
setting a lower level of compression for a higher target priority level; and
setting a higher level of compression for a lower target priority level.

13. The computer-implemented method of claim 9, comprising storing location information for the target object.

14. The computer-implemented method of claim 9, comprising determining the target object is no longer within tracking range.

15. One or more computer-readable media to store instructions that when executed by a processor circuit causes the processor circuit to:
receive audio signals from a microphone array;
determine a first location for at least one sound object from the received audio signals;
receive thermal signals from a thermal sensor;
determine a second location for at least one thermal object from the thermal signals;
determine whether the first location matches the second location; and
identify the at least one sound object as a target object when the first location matches the second location, the matching locations to comprise an origin point for the target object to initiate tracking operations for the target object.

16. The one or more computer-readable media of claim 15, with instructions to:
receive video signals from a video camera;
generate a video image from the video signals; and
send control directives to the video camera or a motorized mount for the video camera to position the target object within the video image.

17. The one or more computer-readable media of claim 16, with instructions to:
receive video signals; and
generate tracking information for the target object based on the received audio signals, thermal signals or video signals, the tracking information to represent changes in position of the target object from the origin point of the target object.

18. The one or more computer-readable media of claim 16, with instructions to:
receive tracking information; and
send control directives to the video camera or the motorized mount for the video camera to keep the target object within the video image.

19. The one or more computer-readable media of claim 16, with instructions to send a reset signal to one or more data acquisition devices to place the one or more data acquisition devices in an initial state.

20. The one or more computer-readable media of claim 16, with instructions to send the video signals to a remote device over a network.
